(19) United States
(12) Patent Application Publication
(10) Pub. No.: US 2005/0283054 A1
(43) Pub. Date: Dec. 22, 2005

(54) Evaluation of a treatment to decrease the risk of a progressive brain disorder or to slow brain aging

(75) Inventor: Eric M. Reiman, Scottsdale, AZ (US)

Correspondence Address: LEWIS AND ROCA LLP, 40 NORTH CENTRAL AVENUE, PHOENIX, AZ, 85004, US

(73) Assignee: Banner Health

(21) Appl. No.: 11/155,711

(22) Filed: Jun. 17, 2005

Related U.S. Application Data
(60) Provisional application No. 60/580,762, filed on Jun. 18, 2004.

(51) Int. Cl. G06G 7/48; G06G 7/58

(52) U.S. Cl. 600/300; 703/11

(57) ABSTRACT

For real persons at risk for Alzheimer's disease, a neurodegenerative disease, or brain aging, a measurement's rate of change can be characterized during or following the real persons' treatment with disease-preventing or neurological age-slowing therapy. For hypothetical persons similar to the real persons at risk for these conditions but who are not so treated, the measurement's rate of change can be characterized over a like time interval. The disease-preventing or age-slowing therapy's efficacy is suggested by a smaller measurement rate of change over the like time interval in the real persons treated than in the hypothetical persons not so treated, even in the absence of clinical decline over the time interval. Measurements of neurodegenerative disease progression will have significantly higher rates of change in persons clinically affected by or at risk for the disease than in those persons at lower risk for the neurodegenerative disease.

### CROSS REFERENCES TO RELATED APPLICATIONS

This application claims priority to U.S. Provisional Application Ser. No. 60/580,762, filed on Jun. 18, 2004, titled “Method For Evaluating The Efficacy Of Putative Primary And Secondary Prevention Therapies In Cognitively Normal Persons At Risk For Brain Disorders”, which is incorporated herein by reference.

### FIELD OF INVENTION

This invention relates to brain disorders and treatments for brain disorders, and is more particularly related to strategies for evaluating the efficacy of treatments for neurological, psychiatric, and related disorders.

### BACKGROUND

The present invention relates generally to methods that utilize imaging techniques to measure the activity and/or structural changes in the human brain to determine the efficacy of putative treatments for brain-related disorders. More particularly, the present invention relates to methods to utilize structural or functional imaging techniques such as PET, SPECT, MRI, or amyloid imaging, as well as other measurements of change over time as surrogate markers to predict efficacy of putative treatments in improving clinical outcome in persons susceptible to Alzheimer's Dementia (AD), Mild Cognitive Impairment (MCI), or other progressive brain disorders and to evaluate the efficacy of putative treatment to slow age-related changes in the brain.

To facilitate indexing to references, square brackets below may indicate reference numbers in the section preceding the claims. No admission is being made by the applicant as to the pertinence of any of the listed references. A presentation is attached following the claims and comprises part of this disclosure.

Brain Disorders and Surrogate Markers

Brain disorders such as Alzheimer's dementia (AD) constitute a rapidly growing public health problem. Clinically, AD is characterized by a gradual and progressive decline in memory and other cognitive functions, including language skills, the recognition of faces and objects, the performance of routine tasks, and executive functions, and it is frequently associated with other distressing and disabling behavioral problems [1-3]. Histopathological features of AD include neuritic and diffuse plaques (in which the major constituent is the β-amyloid protein), neurofibrillary tangles (in which the major constituent is the hyperphosphorylated form of the microtubule-associated protein tau), and the loss of neurons and synapses [4]. In addition to its effects on patients, AD places a terrible burden on the family; indeed, about half of the affected persons' primary caregivers become clinically depressed [5]. According to one community survey, AD afflicts about 10% of those over the age of 65 and almost half of those over the age of 85 [6]. As the population grows older, the prevalence and cost of AD is expected to increase dramatically [7]. For example, by 2050 the prevalence of AD in the United States has been projected to quadruple (from about 4 to 16 million cases, even without assuming an increase in an affected person's life expectancy) and the cost of caring for patients will quadruple (from about 190 to 750 million dollars per year, even without any adjustment for inflation) [8]. An AD prevention therapy is urgently needed to avert an overwhelming public health problem.

Scientific progress has raised the hope of identifying treatments to halt the progression and prevent the onset of AD [9]. This progress includes the discovery of genetic mutations and at least one susceptibility gene that account for many cases of AD; the characterization of other AD risk factors and pathogenic molecular events that could be targeted by potential treatments; the development and use of improved research methods (e.g., in the fields of genomics and proteomics) for the identification of new therapeutic targets; the development of promising animal models, including transgenic mice containing one or more AD genes, which may help clarify disease mechanisms and screen candidate treatments; suggestive evidence that several available interventions (e.g., estrogen-replacement therapy, anti-inflammatory medications, statins {e.g. HMG CoA Reductase inhibitors such as Crestor®, Lipitor® or Pravachol®}, vitamin E, folic acid, and gingko biloba), which might be associated with a lower risk and later onset of AD; the discovery of medications which at least modestly attenuate AD symptoms (e.g., several acetylcholinesterase inhibitors and the N-methyl-D-aspartate [NMDA] inhibitor memantine); and the development of other potentially disease-modifying investigational treatments (e.g., histopathological immunization therapies, drugs which inhibit the production, aggregation, and neurotoxic sequelae of Aβ, drugs which inhibit the hyperphosphorylation of tau, and drugs which protect neurons against oxidative, inflammatory, excitatory, and other potentially toxic events).

Even if a prevention therapy is only modestly helpful, it could provide an extraordinary public health benefit. For instance, a therapy that delays the mean onset of AD by only five years might reduce the number of cases by half [10]. Unfortunately, it would require thousands of volunteers, many years, and great expense to determine whether or when cognitively normal persons treated with a candidate primary prevention therapy develop cognitive impairment and AD. One way to reduce the samples and time required to assess the efficacy of an AD prevention therapy is to conduct a clinical trial in patients with mild cognitive impairment (MCI), who may have a 10-15% rate of conversion to probable AD and commonly have histopathological features of AD at autopsy [11,12]. Randomized, placebo-controlled clinical trials in patients with MCI could thus help establish the efficacy of putative “secondary prevention” therapies. Using clinical outcome measures, the only practical way to establish the efficacy of a “primary prevention” therapy has been to restrict the randomized, placebo-controlled study to subjects in advanced age groups—a strategy which still requires extremely large samples, a study duration of several years, and significant cost. While these strategies are likely to play significant roles in the identification of effective prevention therapies, it remains possible that subjects will require treatment at a younger age or at an even earlier stage of underlying disease for a candidate prevention therapy to exert its most beneficial effects. Those of skill in the art recognize the value of developing putative primary prevention therapies, and they are placing an increasing emphasis on the earliest possible detection of the brain changes associated with the predisposition to this disorder. A new paradigm is needed to reduce the subject samples, time, and cost required to establish the efficacy of putative primary prevention therapies, encourage industry and government agencies to sponsor the required trials, and prevent this growing problem without losing a generation along the way. What is further needed is a means to evaluate putative treatment modalities on additional brain disorders other than AD, including, but not limited to mild cognitive impairment (MCI) or decline in cognitive ability due to other age-related atrophy or other disorders.

Researchers have been using ¹⁸F-fluorodeoxyglucose (FDG) positron emission tomography (PET) and magnetic resonance imaging (MRI) to detect and track changes in brain function and structure which precede the onset of brain disorder symptoms in cognitively normal persons who are at risk for developing brain disorders such as Alzheimer's. Suggested risk factors for AD include older age, female gender, lower educational level, a history of head trauma, cardiovascular disease, higher cholesterol and homocysteine levels, lower serum folate levels, a reported family history of AD; trisomy 21 (Down's syndrome), at least 12 missense mutations of the amyloid precursor peptide (APP) gene on chromosome 21, at least 92 missense mutations of the presenilin 1 (PS1) gene on chromosome 14, at least 8 missense mutations of the presenilin 2 (PS2) gene on chromosome 1, candidate susceptibility loci on chromosomes 10 and 12, and the APOE ε4 allele on chromosome 19 [9,13,14]. Next to age, the APOE ε4 allele is the best-established risk factor for late-onset AD and, thus, it is especially relevant to human brain imaging studies. The APOE gene has three major alleles, ε2, ε3, and ε4 [22]. In comparison with the ε3 allele (the most common variant), the ε4 allele is associated with a higher risk of AD and a younger age at dementia onset, whereas the ε2 allele may be associated with a lower risk of AD and an older age at dementia onset [15-18,23]. In one of the original case-control studies, individuals with no copies of the ε4 allele had a 20% risk of AD and a median age of 84 at dementia onset; those with one copy of the ε4, which is found in about 24% of the population [22], had a 47% risk of AD and a median age of 76 at dementia onset; and those with two copies of the ε4 allele (the ε4/ε4 genotype, found in 2-3% of the population [22]) had a 91% risk of AD by 80 years and a mean age of 68 at dementia onset [17]. In another study, 100% of ε4 carriers with cognitive loss had neuritic plaques at autopsy [24]. In a related study, 23% of their AD cases were attributed to absence of the ε2 allele and another 65% of their cases were attributed to the presence of one or more copies of the ε4 allele [23]. Case-control studies in numerous clinical, neuropathological, and community studies have confirmed the association between the ε4 allele and AD. Farrer et al conducted a worldwide meta-analysis of data from 5930 patients with probable or autopsy-confirmed AD and 8607 controls from various ethnic and racial backgrounds [18]. In comparison with persons with the genotype ε3/ε3, the risk of AD was significantly increased in genotypes ε2/ε4 (odds ratio [OR]=2.6), ε3/ε4 (OR=3.2), and ε4/ε4 (OR=14.9), and the risk of AD was significantly decreased in genotypes ε2/ε3 (OR=0.6), and ε2/ε2 (OR=0.6). Community-based, prospective studies promise to better characterize the absolute risk of AD in persons with each APOE genotype.

Some imaging research has focused on demonstrating that baseline reductions in structural or functional performance with a single imaging measurement, predict subsequent clinical decline in patients with dementia, and that baseline measurements in MCI predict higher rate of conversion to AD. However, these findings are insufficient to demonstrate that the selected brain imaging technique is an adequate surrogate marker for demonstrating prevention of or delayed onset of a disease state. More specifically, the measurement protocols must be able to show that the surrogate marker correlates with clinical severity in patients, and when a change in measurements is attributable to administration of a treatment regimen, it also predicts an improvement in clinical outcome. Prior single baseline imaging techniques are insufficient in this regard.

Linking Functional and Structural Brain Images

Neuroimaging researchers frequently acquire a combination of functional (e.g., positron emission tomography [PET] or functional magnetic resonance imaging [fMRI]) and structural (e.g., volumetric MRI) brain images. The structural MRI data is usually used in PET/fMRI studies for anatomical localization of functional alterations, definition of regions of interest for the co-registered PET/fMRI data extraction, and partial volume correction (Ibanez et al. 1998).

While neuroimages have been most commonly analyzed using univariate methods, multivariate analyses have also been used to characterize inter-regional correlations in brain imaging studies. Multivariate algorithms have included principal component analysis (PCA) (Friston 1994), the PCA-based Scaled Subprofile Model (SSM) (Moeller et al. 1987; Alexander & Moeller 1994), and the Partial Least Squares (PLS) method (McIntosh et al. 1996). These methods have typically been used to characterize regional networks of brain function (and more recently brain anatomy) and to test their relation to measures of behavior. Such multivariate methods, however, have not yet been used to identify patterns of regional covariance between functional and structural brain imaging datasets.

A major challenge to the multivariate analysis of regional covariance with multiple imaging modalities is the extremely high dimensionality of the data matrix created by including relatively high-resolution neuroimaging datasets. What is needed is a strategy to make computation dimensional datasets with covariance analysis using multivariate methods feasible.

### DISCLOSURE OF THE INVENTION

In view of the foregoing, it is an object of the present invention to improve various problems associated with the prior art. To this end, an object of the invention is to provide a method to evaluate putative therapies to improve clinical outcomes in patients at risk for brain-related disorders. It is to be understood that the following description is exemplary and explanatory only and is not restrictive of the invention, as claimed. Thus, the present invention comprises a combination of features, steps, and advantages that enable it to overcome various deficiencies of the prior art. The various characteristics described, as well as other features, will be readily apparent to those skilled in the art upon reading the following detailed description of the preferred embodiments of the invention, and by referring to the accompanying drawings.

Longitudinal brain imaging studies have been conducted with ε4 homozygotes, ε4 heterozygotes (all with the ε3/ε4 genotype), and ε4 non-carriers who were initially late middle-aged (i.e., younger than the suggested median onset of AD), cognitively normal, and individually matched for their gender, age, and educational level. Since individuals with the ε4/ε4 genotype have an especially high risk of AD, the study of this subject group is intended to optimize the power to characterize the brain and behavioral changes which precede the onset of cognitive impairment and eventually relate these changes to the subsequent onset of MCI and AD. Since individuals with the ε3/ε4 genotype have an increased risk of AD and comprise about 20-23% of the population [22], the study of this subject group extends the findings to a larger segment of the population and increases the number of individuals who would be eligible to participate in future clinical trials of putative primary prevention therapies. The study of ε4 noncarriers who are individually matched for gender, age, and educational level could optimize the power to characterize the brain and behavioral changes associated with normal aging and permit us to distinguish them from those age-related changes preferentially related to the presence of the ε4 allele and the subsequent onset of AD. As other risk factors are confirmed, it should be possible to extend the brain imaging paradigm of the present invention to the study of cognitively normal persons who are at differential risk for AD independent of (and in conjunction with) their APOE genotype.

PET in the Study of AD

FDG PET, which provides measurements of the cerebral metabolic rate for glucose (CMRgl), is the most extensively used functional brain imaging technique in the study, early detection, and tracking of AD. FDG PET reveals characteristic abnormalities in patients with AD, including abnormally low posterior cingulate, parietal, and temporal CMRgl, abnormally low prefrontal and whole brain CMRgl in more severely affected patients, and a progressive decline in these and other measurements over time [25-39]. These abnormalities, which are correlated with dementia severity and predict subsequent clinical decline and the histopathological diagnosis of AD [28-31,33-35,37,38], could be related to a reduction in the activity or density of terminal neuronal fields or perisynaptic glial cells that innervate these regions [40-42], a metabolic dysfunction [42-44], or a combination of these factors. They do not appear to be solely attributable to the combined effects of atrophy and partial-volume averaging [36].

Brain abnormalities can be detected prior to the onset of dementia [8,9,44-46]. In comparison with the ε4 noncarriers, the ε4 homozygotes and heterozygotes each have abnormally low CMRgl in the same brain regions as patients with probable AD [9,46]. Despite no significant differences in clinical ratings or neuropsychological test scores and no significant interactions between these measurements and time, the ε4 heterozygotes have significantly higher 2-year rates of CMRgl decline [8]. Based on these data, we estimated the power of PET to test the efficacy of candidate prevention therapies to attenuate this decline in 2 years [8]. In complementary PET studies of non-demented ε4 carriers and noncarriers, who were about 10 years older, had memory concerns, and had slightly lower MMSE scores; furthermore, lower CMRgl measurements in the posterior cingulate and parietal cortex were correlated with a subsequent decline in memory [45,47]. While it remains possible that the CMRgl abnormalities reflect aspects of the ε4 allele unrelated to AD, PET studies suggest that these abnormalities are related to the development of this disorder. While there may be a few differences [48,49], patients with probable AD appear to have a similar pattern of reductions in regional CMRgl whether or not they have the ε4 allele [50,51]; and, as previously noted, the CMRgl abnormalities in patients with probable AD predict the subsequent progression of dementia and the histopathological diagnosis of AD [37,38], are progressive [28-31,39], and are correlated with dementia severity [34].

Other promising PET radiotracer techniques have been developed for the study of AD. [11C] methylpiperidinyl propionate (PMP) PET provides estimates of acetylcholinesterase activity and has been used to detect deficits in patients with probable AD; this radiotracer method could be used to evaluate the extent of central inhibition by established or investigational acetylcholinesterase inhibitors and help optimize dosage schedules [52]. [11C](R)-PK11195 PET provides estimates of peripheral benzodiazepine receptor binding, a putative marker of neuroinflammation; it has been used to detect abnormally increased measurements and herald the subsequent onset of atrophy in patients with probable AD, and it could be used to track the course of neuroinflammation in AD and characterize the central anti-inflammatory effects of medications [53]. Researchers have recently developed promising PET radiotracer methods for the assessment of AD histopathology [54,55]. Additional research is needed to further evaluate these methods, identify the most suitable radioligands and tracer-kinetic models, and use them to characterize, compare, and track measurements in patients with AD and normal controls.)

MRI in the Study of AD

Volumetric MRI studies reveal abnormally high rates of brain atrophy in patients with probable AD, including progressive reductions in the volume of the hippocampus, entorhinal cortex, and whole brain and progressive enlargement of the ventricles and sulci [56-85]. Embodiments of the MRI embodiment of the present invention comprise T1-weighted volumetric MRI measurements of hippocampal, entorhinal cortex, and whole brain volume and are used to provide structural brain imaging measurements in the early detection and tracking of AD; they have roles in the assessment of candidate treatments to modify disease progression. MRI studies find significantly smaller hippocampal volumes in patients with probable AD [56-73] and non-demented persons at risk for AD[86-97], correlations between reduced hippocampal volume and the severity of cognitive impairment [60,64,65], and progressive declines in hippocampal volume during the course of the illness [61,77,92]. Methods for the reliable characterization of entorhinal cortex volume have recently been developed and used in the early detection and tracking of MCI and AD [68,73-76,79,80,92].

Fox et al. have developed a semi-automated method for the measurement of whole brain atrophy in individual human subjects following the coregistration and digital subtraction (DS) of MRI's [81-84]. They found significantly higher rates of whole brain atrophy in patients with probable AD than those associated with normal aging [81-84], as well as significantly higher rates of whole brain atrophy shortly before the onset of dementia in persons at risk for AD [96,97], and they have estimated the statistical power of this method to test the efficacy of candidate treatments to attenuate these atrophy rates [84]. We have recently developed and tested a fully automated algorithm for the measurement of brain atrophy from sequential MRI's using an iterative principal component analysis (IPCA), have applied it the study of patients with AD, our cognitively normal APOE ε4 homozygotes, heterozygotes, and noncarriers, and transgenic mice [98-102]. Other embodiments for the analysis of volumetric MRI's include but are not limited to the use of “voxel-based morphometry (VBM) to create probabilistic brain maps to compute regional alterations in gray matter or white matter [103-106]; and the use of non-linear warping algorithms to characterize alterations in the size and shape of the hippocampus [107], multiple brain regions [85], variations in gyral and sulcal patterns [108], and reductions in gray matter [108,109].

PET and MRI in the Evaluation of Putative AD Treatments

Following Temple's commonly cited definition [110], “A surrogate endpoint of a clinical trial is a laboratory measurement or a physical sign used as a substitute for a clinically meaningful endpoint that measures directly how a patient feels, functions, or survives. Changes induced by a therapy on a surrogate endpoint are expected to reflect changes in a clinically meaningful endpoint.” According to Fleming and DeMets [111], a valid surrogate endpoint is not just a correlate of the clinical outcome; rather, it should reliably and meaningfully predict the clinical outcome and it should fully capture the effects of the intervention on this outcome. Citing several examples, they note several ways in which an otherwise promising surrogate endpoint might fail to provide an adequate substitute for a clinical endpoint. Although few if any surrogate endpoints have been rigorously validated, the 1997 United States “FDA Modernization Act” authorizes the approval of drugs for the treatment of serious and life-threatening illnesses, including AD, based on its effect on an unvalidated surrogate [112]. In order to promote the study and expedite the approval of drugs for the treatment of these disorders, “fast track” approval” may be granted if the drug has an effect on a surrogate marker that is “reasonably likely” to predict a clinical benefit; in this case, the drug sponsor may be required to conduct appropriate post-marketing studies to verify the drug's clinical benefit and validate the surrogate endpoint [112].

FDG PET measurements of posterior cingulate, parietal, temporal, and prefrontal CMRgl and volumetric MRI measurements of hippocampal, entorhinal cortex, and whole brain volume are established surrogate markers for the assessment of putative drugs in the treatment of AD. These surrogate endpoints are not rigorously validated, partly because validation may actually require demonstration of these endpoints to account for the predicted clinical effect using several established disease-modifying treatments. Still, these brain imaging measurements are “reasonably likely” to predict a drug's clinical benefit in the treatment of AD. They have much greater statistical power than traditional outcome measures [39], reducing the potential cost of proof-of-concept studies. They are “reasonably likely” to determine a drug's disease-modifying effects, helping to distinguish a drug's disease-modifying from symptomatic effects. As discussed below, these brain-imaging measurements may permit the efficient discovery of prevention therapies in non-demented persons at risk for AD [8,84], and they may assist in the pre-clinical screening of candidate treatments in transgenic mice and other putative animal models of AD [102,103,133]. For all of these reasons, FDG PET and volumetric MRI have important and emerging roles in the evaluation of putative disease-modifying candidate drugs in the treatment and prevention of AD.

When using FDG PET in a clinical trial of a putative drug for the treatment or prevention of AD, we recommend (a) the use of a state-of-the-art imaging system with an axial field-of-view that covers the entire brain; (b) data acquisition in the three-dimensional mode, thus permitting the use of lower radiation doses, (c) the use of a non-invasive, image-derived input function, thus permitting the computation of quantitative measurements (in case CMRgl reductions are so extensive that they affect measurements in the whole brain or relatively spared regions, like the pons, that would otherwise be used to normalize images for the variation in absolute measurements); (d) data acquisition in the “resting state” (e.g., eyes closed and directed forward) rather than during the performance of a behavioral task (since the resting state has been used most extensively to track the progression of CMRgl changes in patients with AD and non-demented persons at risk for the disorder and since any effects of a drug on task performance could confound interpretations about the drug's putative disease-modifying effects); (e) the use of an automated brain mapping algorithm to characterize and compare regional CMRgl declines in the active treatment and placebo treatment arms (to date, SPM99 has been the most extensively used algorithm for tracking CMRgl declines in patients with AD and non-demented patients at risk for the disorder; (f) quality assurance procedures to maximize the quality and standardization of image-acquisition and image-analysis procedures at different sites; and (g) a single site for the technical coordination and the centralized storage and analysis of data in multi-center studies.

In the design of clinical imaging trials using FDG PET (and volumetric MRI), we recommend (a) efforts to control or account for potentially confounding effects, such as medication effects (e.g., stratifying samples for use of an approved medication, discouraging the introduction of new medications during the trial, and minimizing or accounting for the use of medications prior to the PET session) and changes in depression ratings; (b) the use of baseline, early, and end-of-treatment scans (performance of the early scan after a drug's steady state and relevant pharmacodynamic effects would help characterize and contrast a medication's state-dependent effects on local neuronal activity or glucose metabolism and its disease-modifying effects; and (c) the use of additional scans as indicated (e.g., to evaluate the time course of an effect, increase statistical power, or incorporate a randomized start or withdrawal design). (d) Although not required, a randomized start or withdrawal design [112] could be used to further support a drug's disease-modifying effects. In a randomized start design, patients initially randomized to the placebo arm and treated for an appropriate time are then re-randomized to active medication or placebo; a disease-modifying effect would be inferred if the change in the surrogate endpoint between the beginning and end of the study is significantly smaller in the patients initially randomized to the active treatment arm (i.e., treated longer) than those subsequently randomized to the active treatment arm. In a randomized withdrawal design, patients initially randomized to the active treatment arm and treated for an appropriate time are then re-randomized to active medication or placebo; a disease-modifying effect would be inferred if the change in the surrogate endpoint is significantly smaller in the patients who were initially randomized to the active treatment arm and subsequently randomized to placebo than those who were treated with placebo throughout the study. Practically, a randomized start design may be preferred since it may be difficult to justify drug discontinuation in those who believe that the medication has been helpful. (e) Even if the data is not necessary for accelerated drug approval, we strongly recommend efforts to relate a drug's short-term effects on surrogate endpoint (e.g., 6-month effects in patients with probable AD or 12-months effects in patients with MCI) to their subsequent clinical course (e.g., subsequent clinical decline in patients with probable AD or 3-year conversion rate to probable AD in patients with MCI)—information that will help validate the use of these surrogate markers (and support the use of shorter study intervals) for candidate drug and others to be studied in the future. (f) We strongly encourage the combined use of FDG PET and volumetric MRI in the study of a candidate treatment. Using an individual brain imaging technique, there is a small possibility that a drug's effect on a surrogate endpoint might be unrelated to a disease-modifying effect (e.g., an increase in neuronal activity or brain swelling) or that a drug's effect on a surrogate end-point might actually mask its disease-modifying effect (e.g., a contraction in brain size due to a drug's osmotic or perhaps even plaque-clearing effects). The combined used of complementary imaging techniques would provide converging evidence in support of a drug's disease-modifying effects. It would further reduce the small possibility that the drug's effect on an individual surrogate endpoint is unrelated to its effect on disease progression (an advantage in seeking approval for a drug's disease-modifying effect). It would minimize the chance that a drug effect on one of the surrogate endpoints would mask its disease-modifying effects (an advantage in proof-of-concept studies). Embedding both of the these imaging modalities in clinical trials would maximize the chance of validating one or both surrogate endpoints and help support their role in the efficient discovery of primary prevention therapies. We believe that these advantages far outweigh the additional costs and note that both of these imaging modalities are now widely available. (g) Finally, we wish to encourage the application of these imaging techniques to the study of cognitively normal APOE E4 carriers in primary prevention trials. In order to conduct primary prevention trials in these subjects, researchers and ethicists may consider two ways to address the risk of providing genetic information to cognitively normal research participants: withholding information from subjects about their genetic risk with their prior informed consent and including persons with and without a genetic risk for AD (as we have been done in our naturalistic studies) or (b) counseling potential research subjects about the uncertainties and risks involved in receiving information about their genetic status, obtaining their informed consent to receive this information, and restricting the study to persons at genetic risk for the disorder.

PET In The Study Of Cognitively Normal APOE ε4 Carriers And Noncarriers

In order to study cognitively normal persons at differential genetic risk for AD, we have used newspaper ads to recruit persons who denied any memory concerns and were medically well. The subjects agreed that they would not receive any information about their APOE genotype (since this information cannot be used to predict with certainty whether or when a person will develop AD) and provided their informed consent. Blood samples were then drawn and APOE genotypes characterized. For each APOE ε4 carriers who agreed to participate in our imaging trials, one ε4 noncarrier was matched for his or her gender, age (within 3 years), and educational level (within 2 years). The subjects had quantitative FDG PET measurements of CMRgl as they rested quietly with their eyes closed, a volumetric T1-weighted MRI, a clinical examination, structured psychiatric interview, and depression rating scale, the Folstein Mini-Mental State Examination (MMSE), and batteries of neuropsychological tests and psycholinguistic tasks. In our ongoing longitudinal study, we have begun to acquire these data every 2 years in 160 cognitively normal individually matched ε4 homozygotes, heterozygotes, and noncarriers 47-68 years of age with a reported first-degree family history of probable AD. In other studies, we have begun to characterize and compare these measurements in cognitively normal ε4 carriers and noncarriers 20-80 years of age irrespective of their reported family history or probable AD.

Baseline Measurements

We originally sought to test the hypothesis that cognitively normal, late middle-aged APOE ε4 homozygotes, at a particularly high risk of AD, have abnormally low PET measurements in the same brain regions as patients with probable AD [46]. APOE genotypes were characterized in cognitively normal persons 50-65 years of age with a reported first-degree family history of probable AD. For each of the 11 ε4 homozygotes who agreed to participate in our imaging study, 2 ε4 noncarriers were matched for their gender, age (within 3 years), and educational level (within 2 years. The ε4 homozygotes had a mean age of 55 (range 50-62), a mean MMSE score of 29.4 (range 28-30), and no significant differences from the controls in their clinical ratings or neuropsychological test scores. To characterize regions of the brain with abnormally low CMRgl in patients with probable AD, an automated was initially used to create a three-dimensional stereotactic surface projection statistical map comparing the data from 37 patients with probable AD and 22 normal controls (mean age 64) provided by researchers at the University of Michigan [32,34]. As previously demonstrated, the patients with probable AD had abnormally low CMRgl bilaterally in posterior cingulate, parietal, temporal, and prefrontal cortex, the largest of which was in the posterior cingulate corte. To characterize regions of the brain with reduced CMRgl in the cognitively normal ε4 homozygotes, the same brain mapping algorithm was used to create a three-dimensional surface projection statistical map comparing the data from our homozygotes and non-carriers; this map was then superimposed onto the map of CMRgl abnormalities in the patients with probable AD (FIG. 1) [46]. As predicted, the ε4 homozygotes had abnormally low CMRgl bilaterally in the same posterior cingulate, parietal, temporal, and prefrontal regions as the patients with probable AD (FIG. 1) [46]. The largest reduction was in the posterior cingulate cortex, which is pathologically affected in AD and might provide the earliest metabolic indicator of the predisposition to Alzheimer's dementia [32]. The ε4 homozygotes also had abnormally low CMRgl bilaterally in additional prefrontal regions (FIG. 1), which PET, MRI, and neuropathological studies suggest are preferentially affected during normal aging [46,114-118]—and which have led us to postulate that the APOE ε4 allele accelerates normal aging processes which are necessary but not sufficient for the development of AD [46].

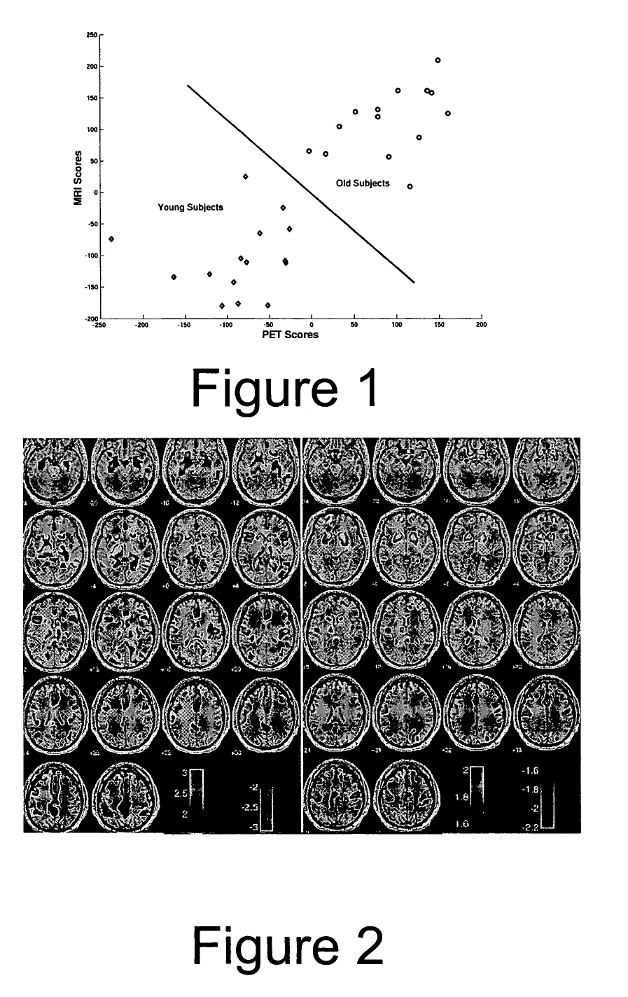

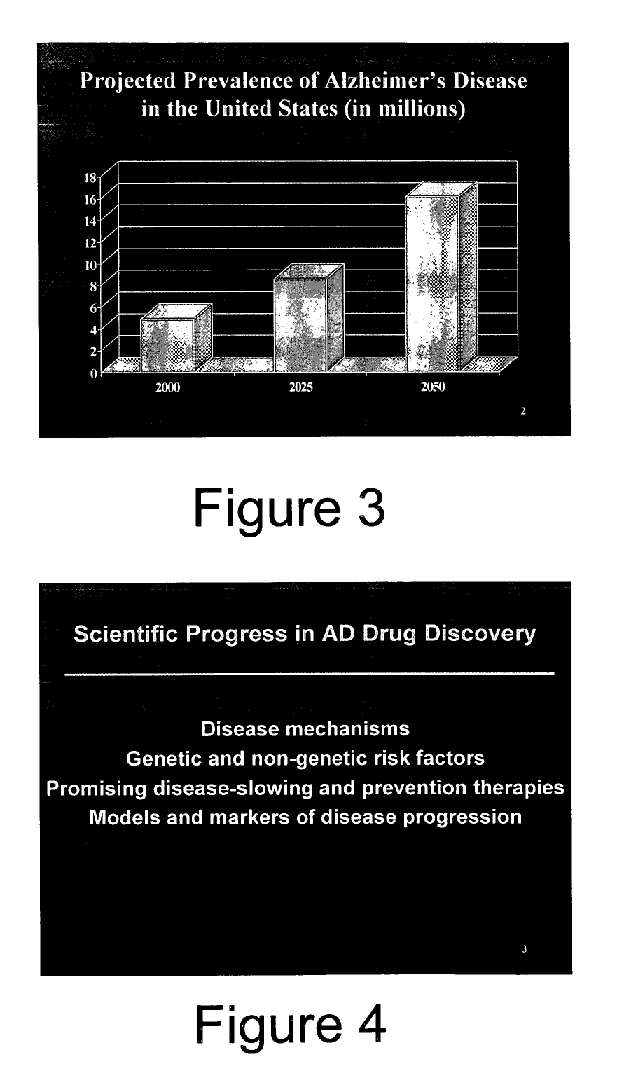

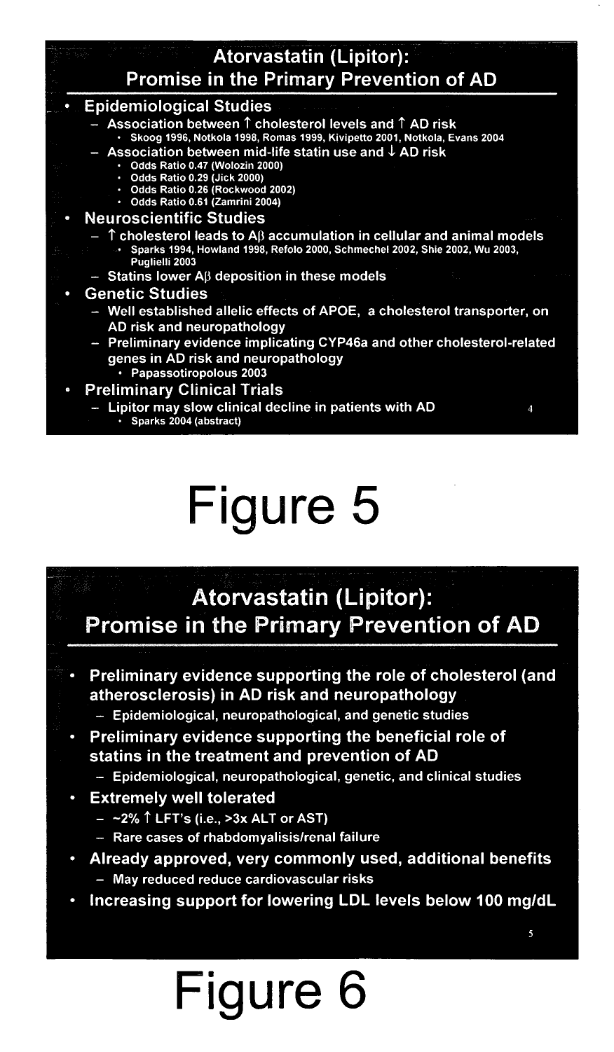

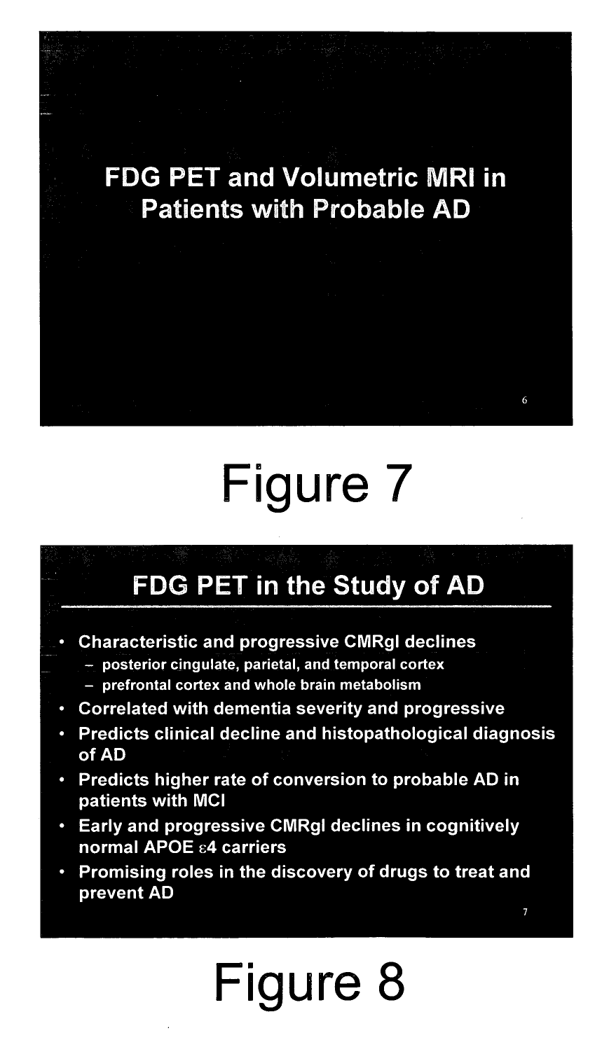

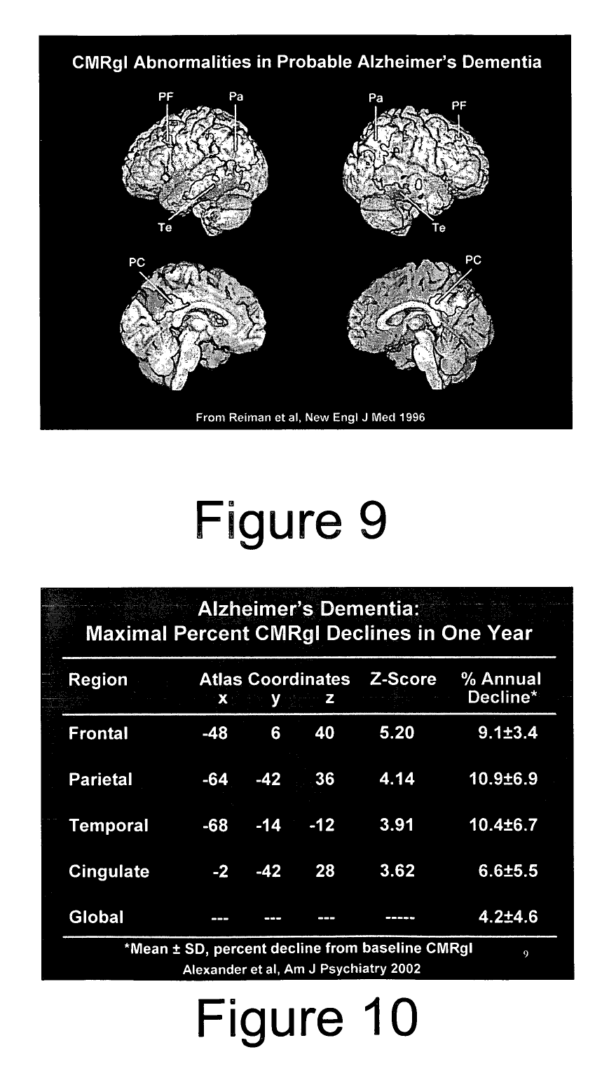

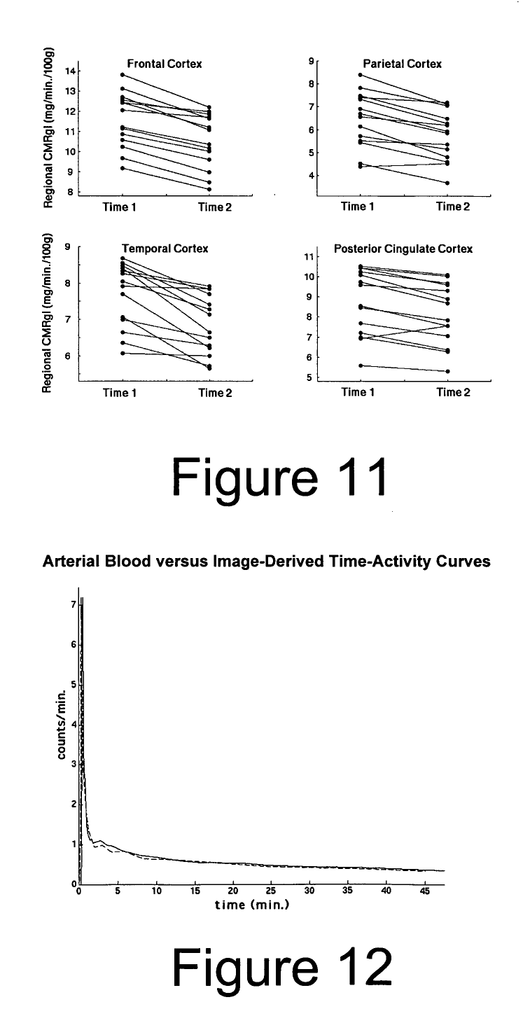

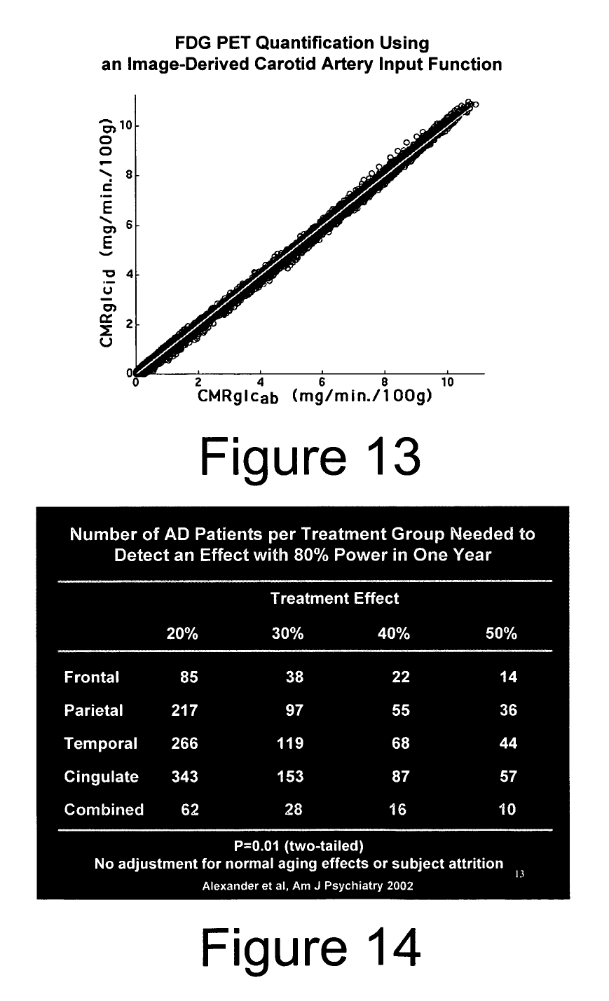

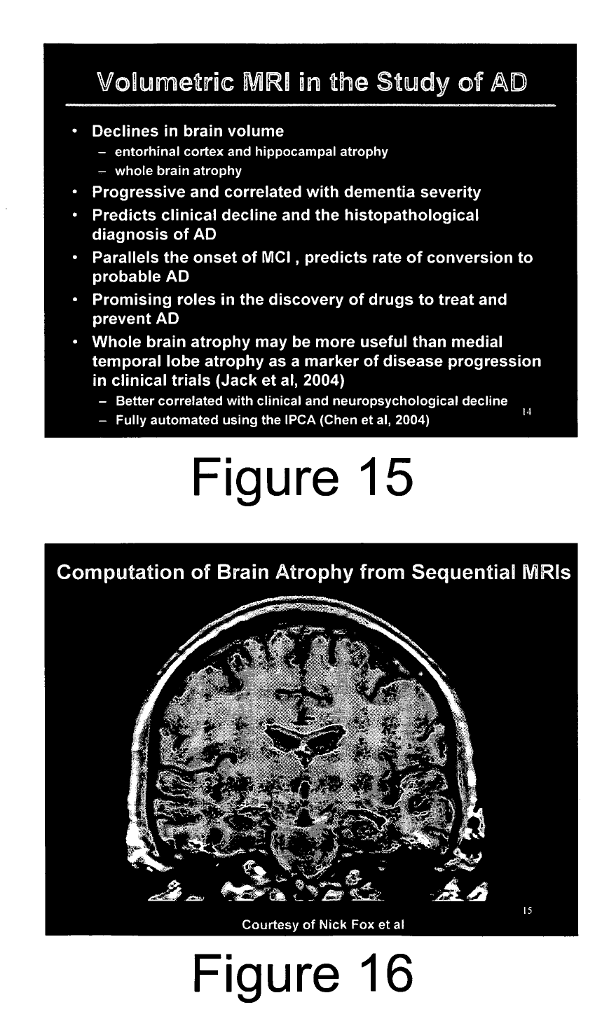

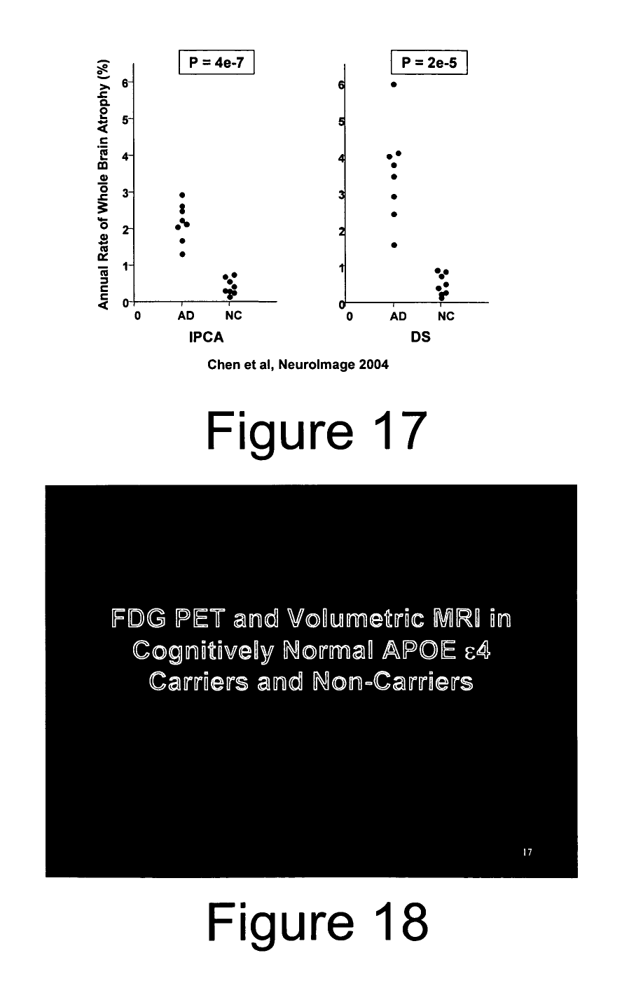

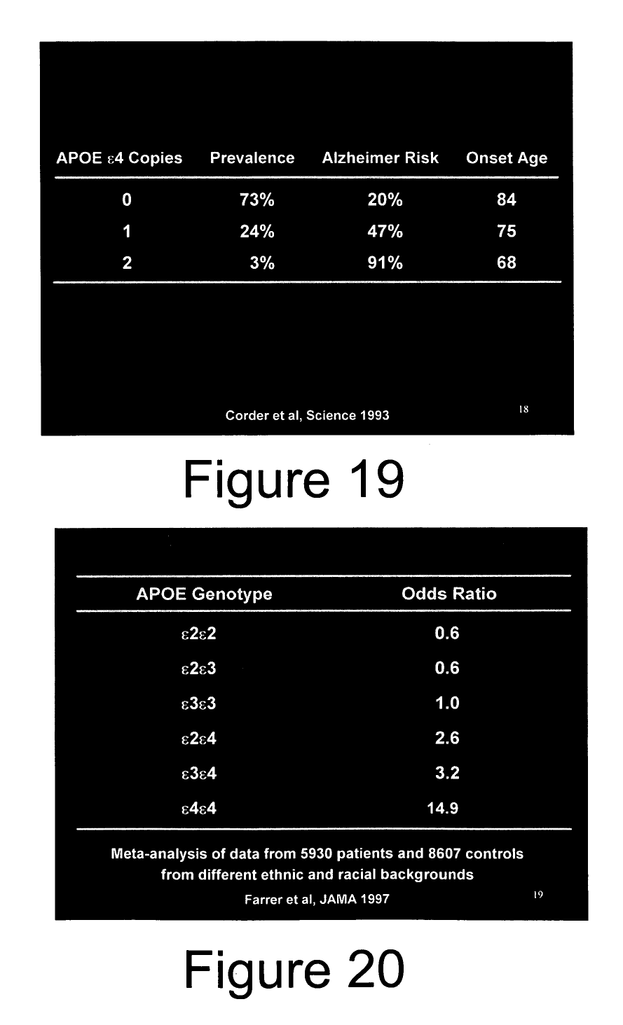

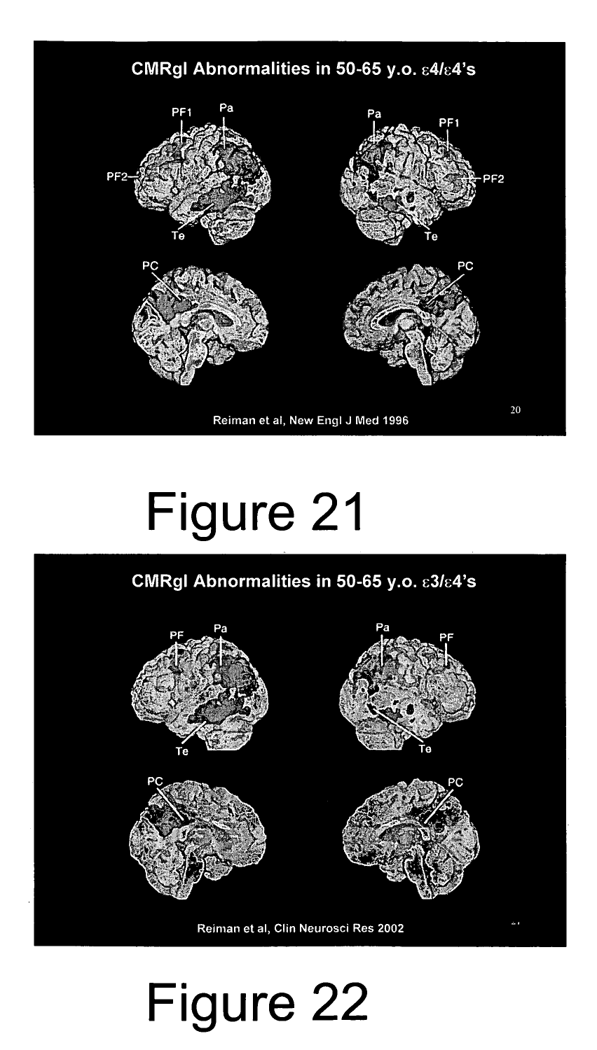

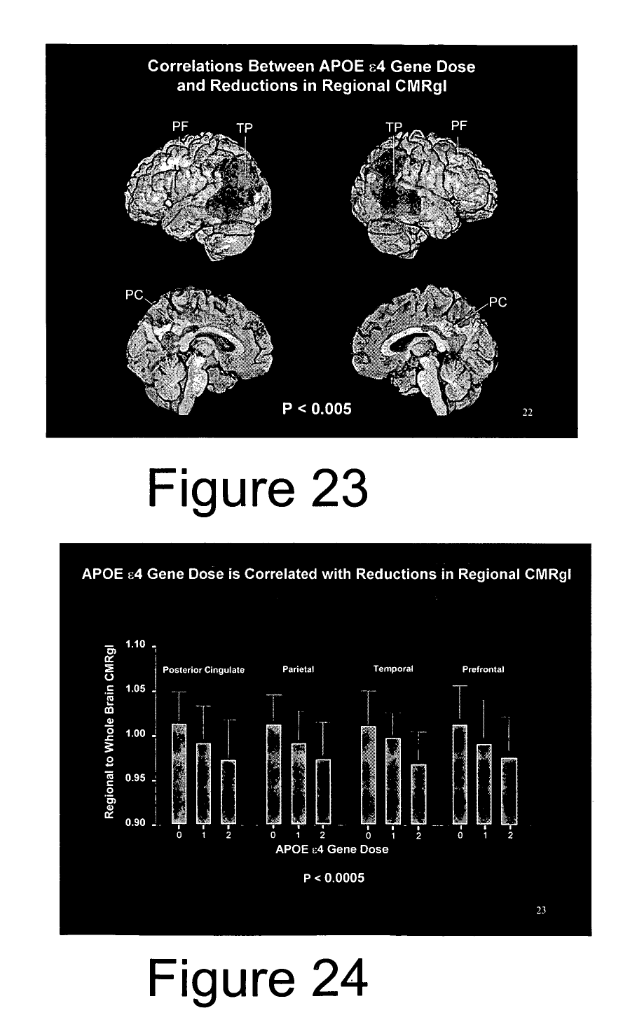

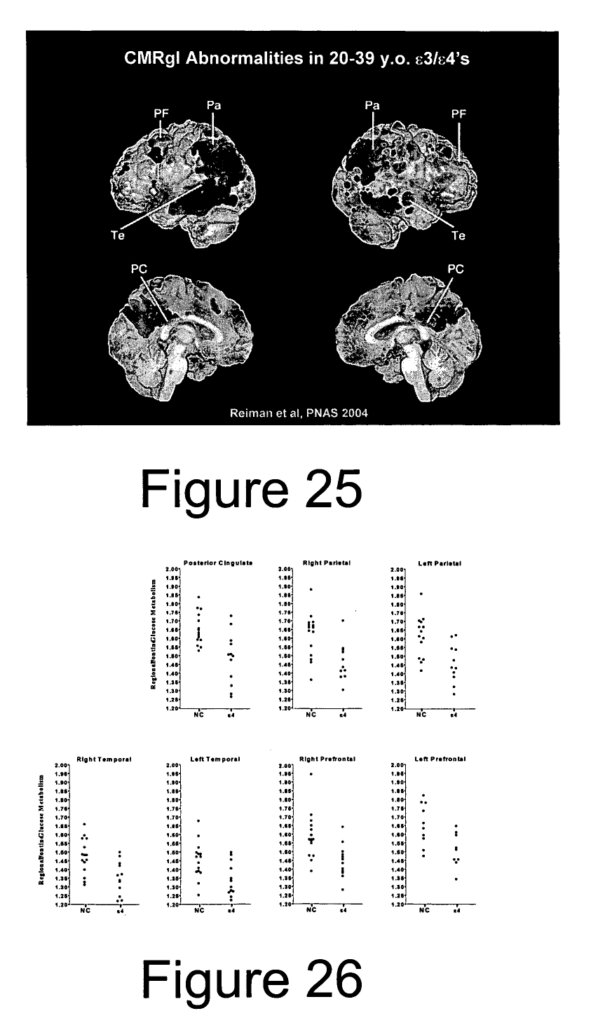

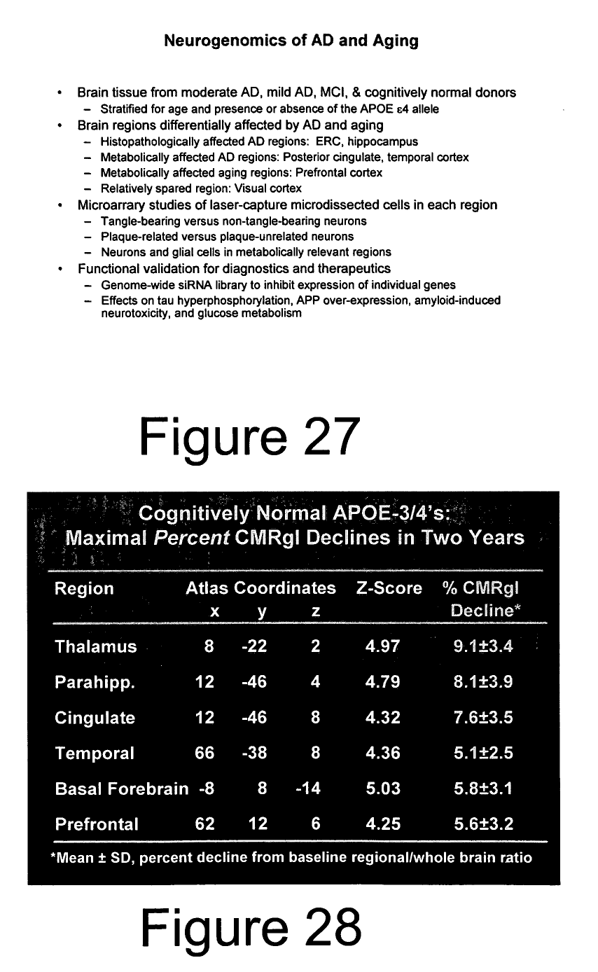

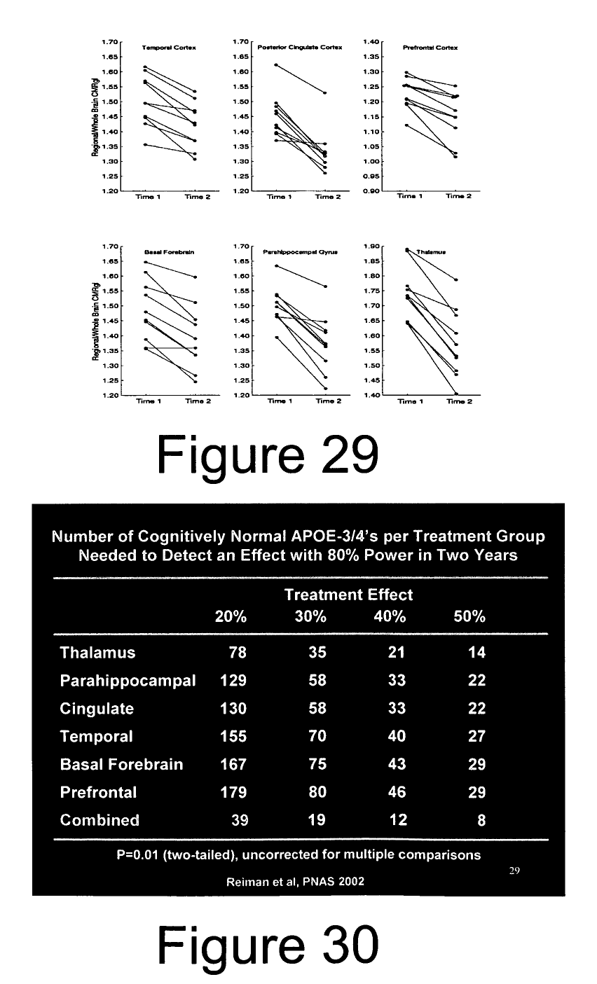

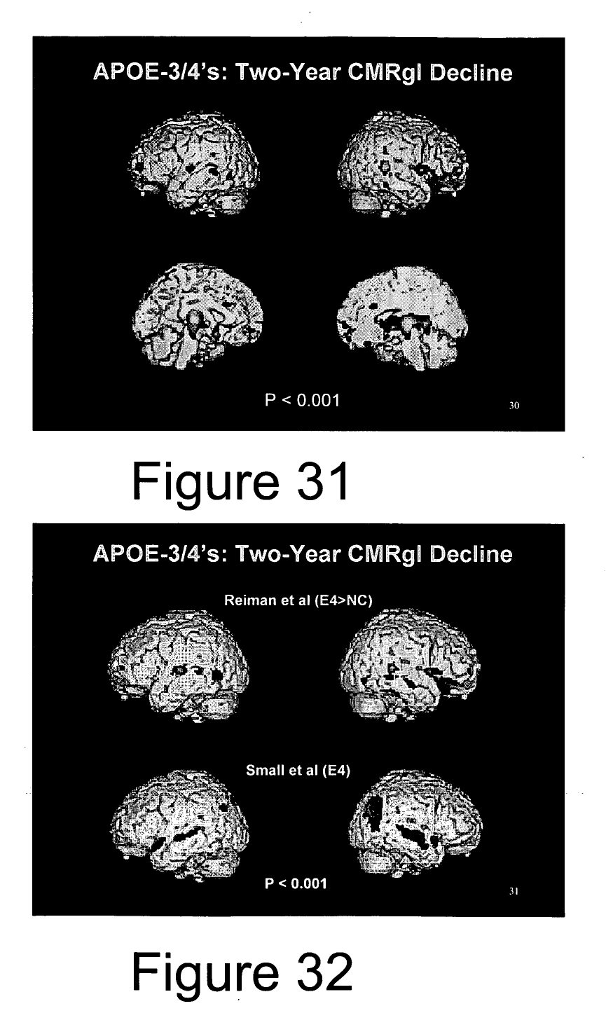

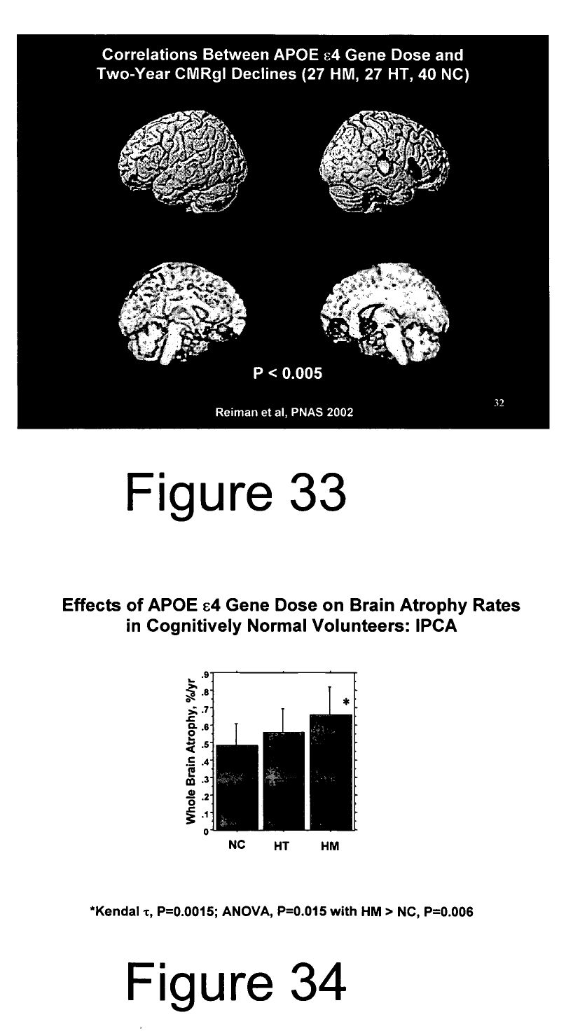

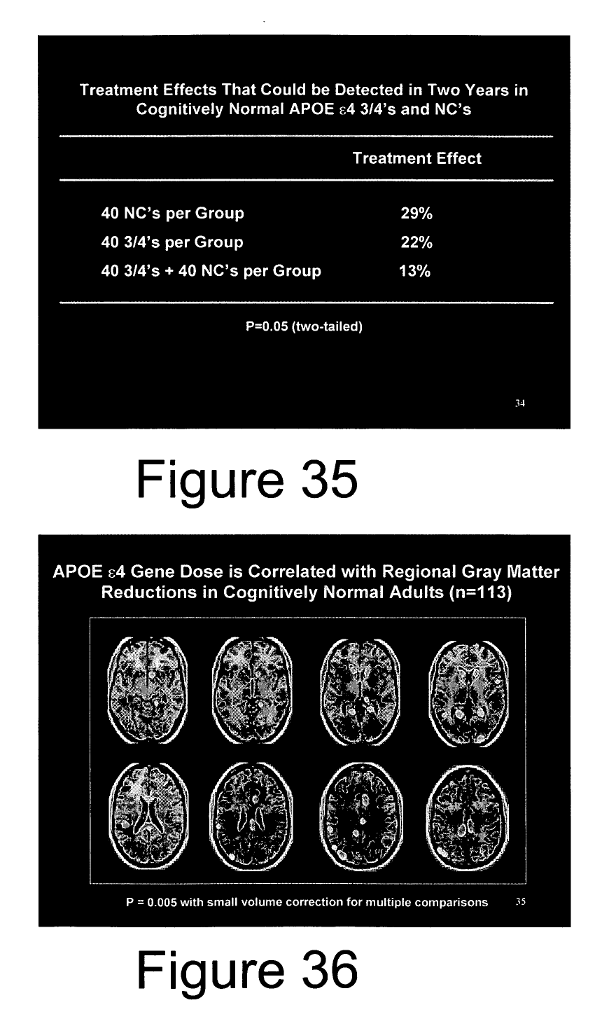

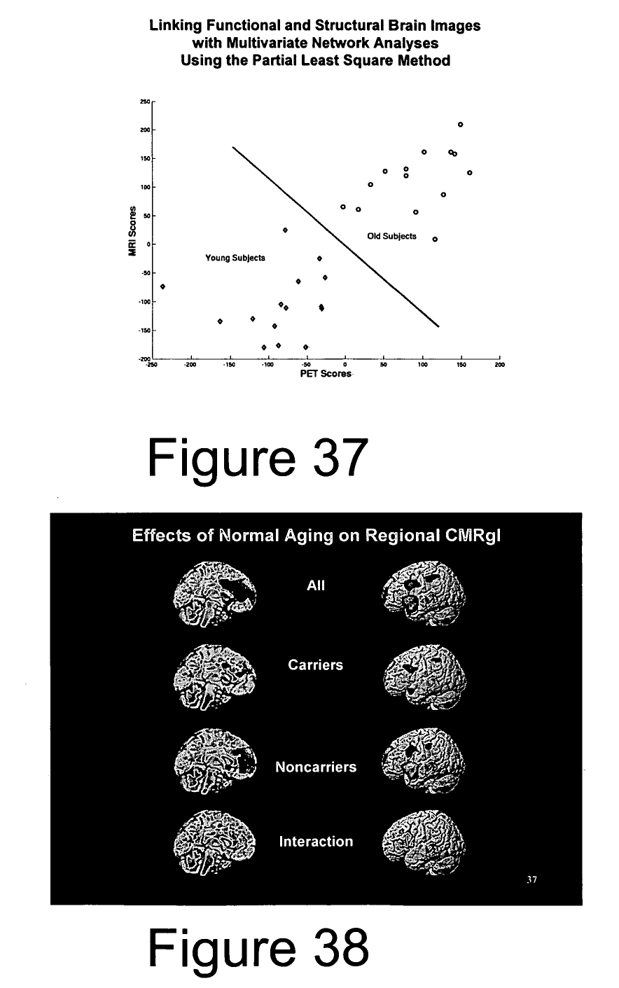

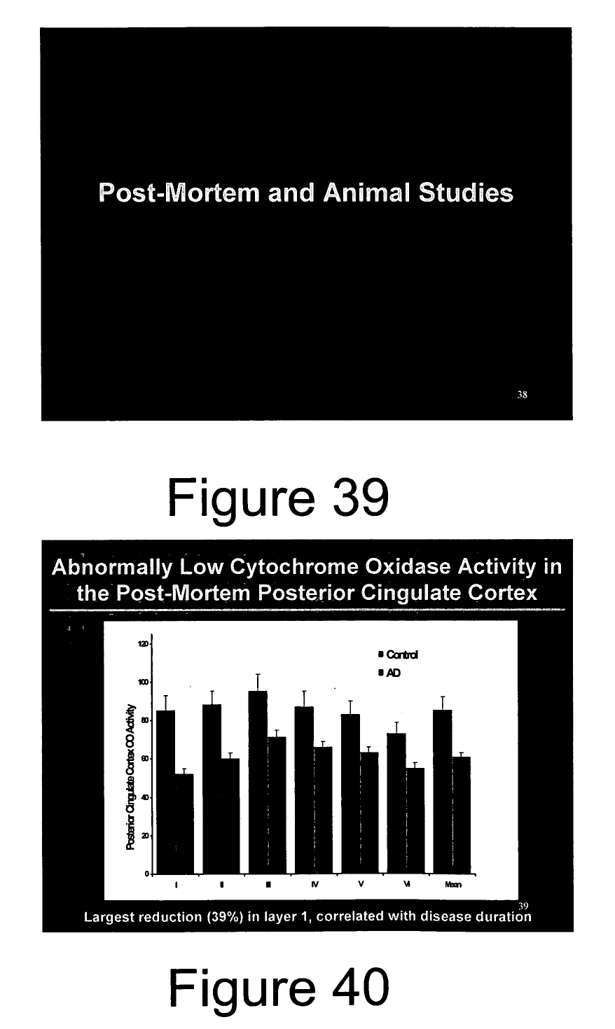

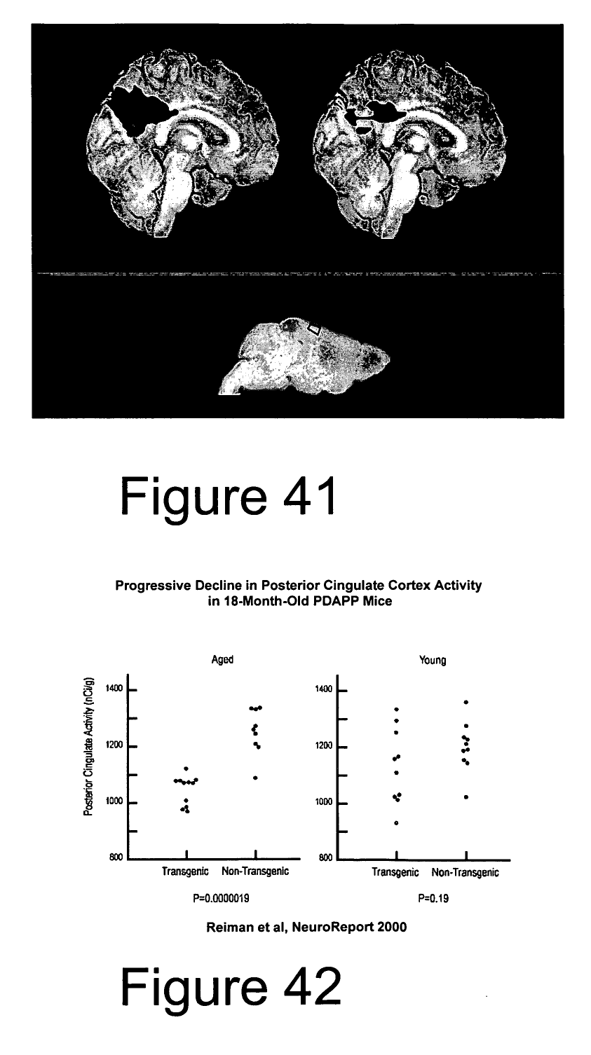

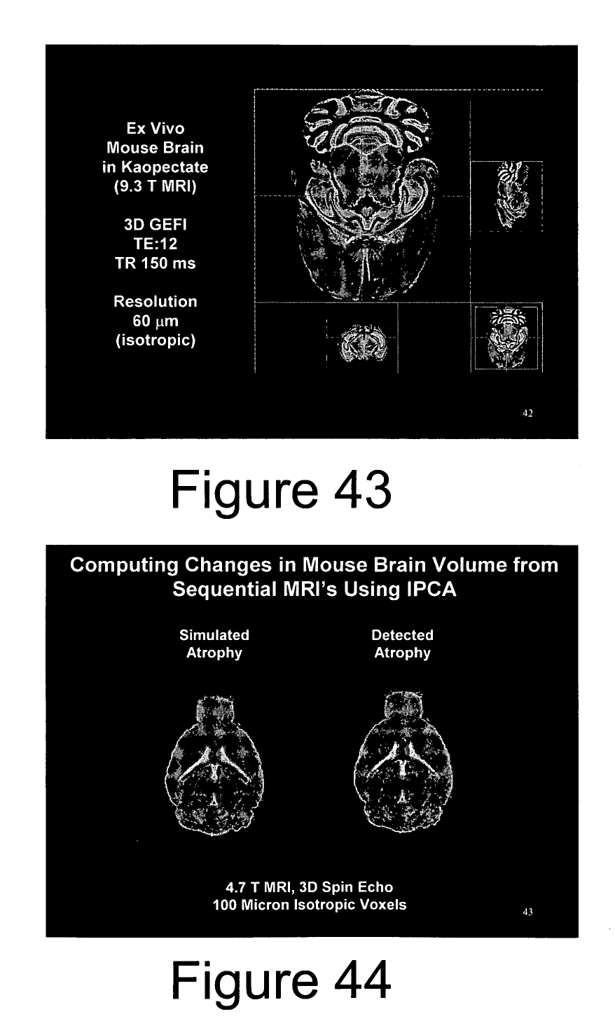

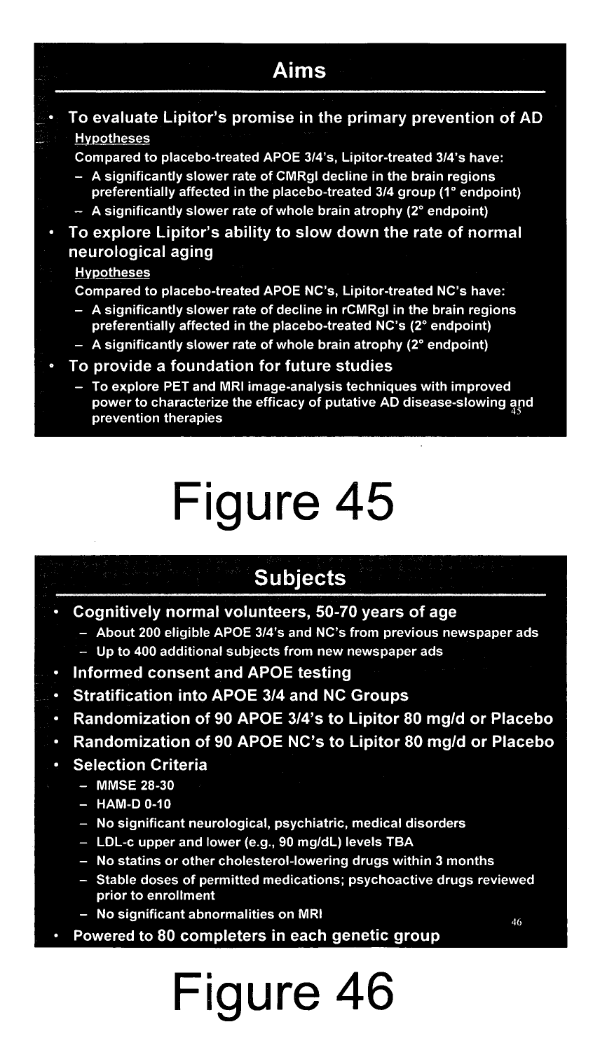

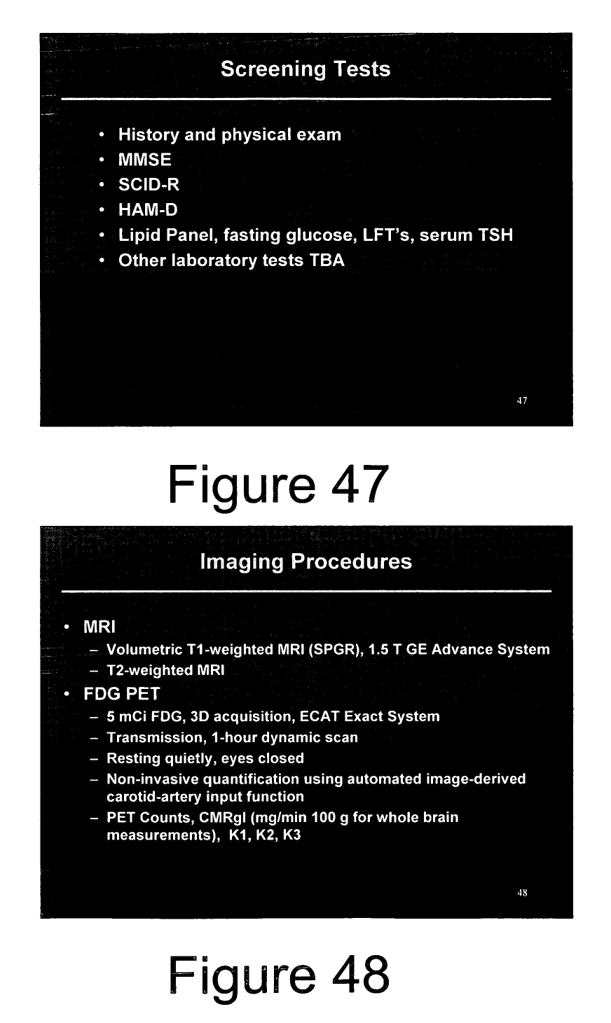

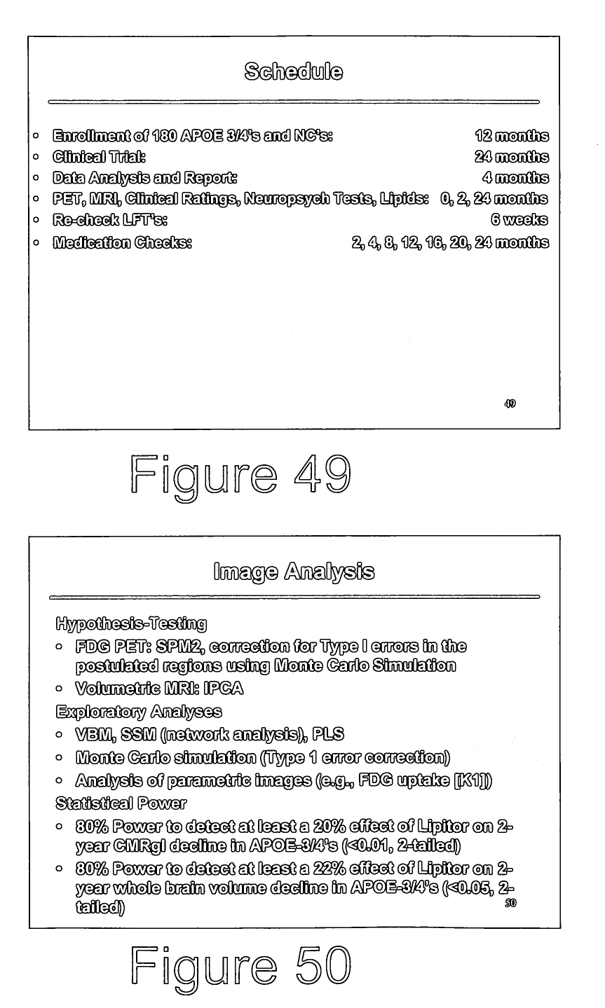

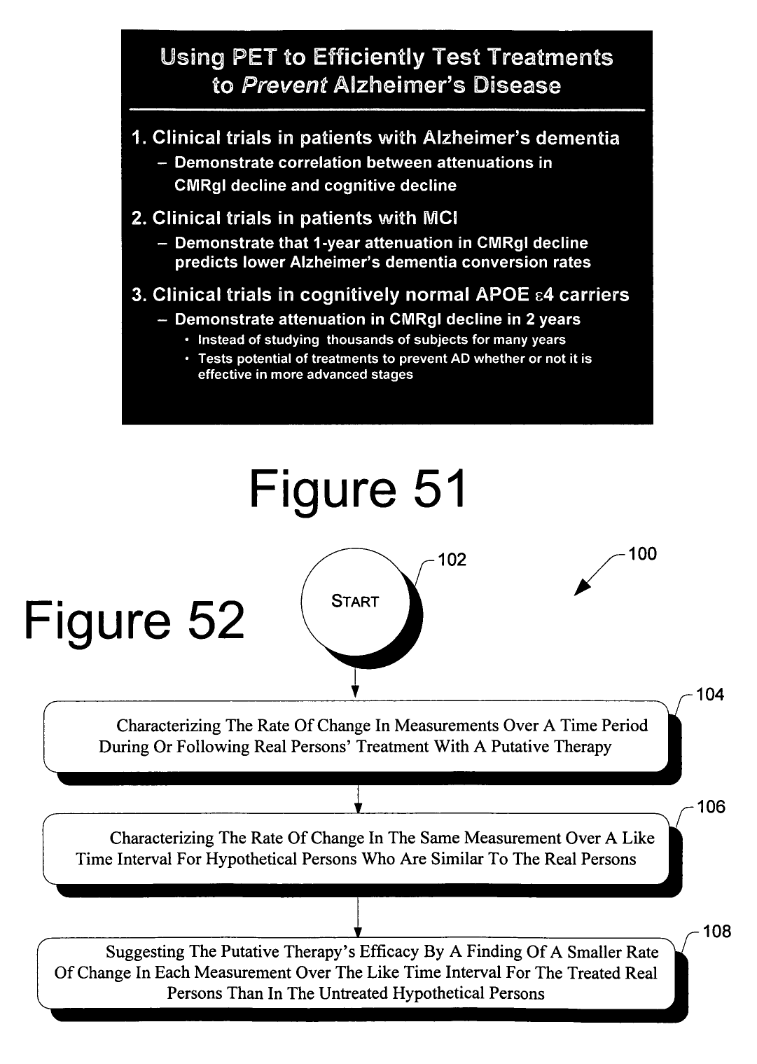

We subsequently sought to detect abnormalities in cognitively normal APOE ε4 heterozygotes [8,9], thus providing a foundation for using PET to efficiently test the potential of candidate primary prevention therapies in this large segment of the population. Eleven cognitively normal ε4 heterozygotes (50-63 years of age, all with the E3/ε4 genotype) who reported family history of probable AD in a first-degree relative were matched to our original group of ε4 homozygotes and non-carriers for gender, age, and educational level [9]. The ε4 heterozygotes had perfect scores on the MMSE and no impairments in their neuropsychological test scores. Using the same brain-mapping algorithm employed in our original study, the E4 heterozygotes had significantly reduced CMRgl bilaterally in the same regions of posterior cingulate, parietal, and temporal cortex as patients with probable AD (FIG. 2) [9]. Like the ε4 homozygotes, the largest CMRgl reduction was located in the posterior cingulate cortex. Unlike the ε4 homozygotes, the ε4 heterozygotes did not have significant reductions in additional prefrontal regions, which we postulate will be affected at an older age than that observed in the ε4 homozygotes.

We have recently extended these findings to 160 cognitively normal persons in this age group (including 36 ε4 homozygotes, 46 ε4 heterozygotes, and 78 noncarriers, who enrolled in our longitudinal study and followed every two years [119]. As in our earlier reports, the ε4 carriers had abnormally low CMRgl in the posterior cingulate, parietal, temporal, and prefrontal cortex, which were not solely attributable to the combined effects of atrophy and partial volume-averaging [119]. Lower CMRgl in each of these regions was significantly correlated with ε4 gene dose, which has been related to a higher risk of AD and a lower mean age at the onset of dementia [119].

We have also extended our findings to the comparison of 10 cognitively normal ε4 heterozygotes and 15 ε4 noncarriers 20-39 years of age, who were recruited irrespective of their reported family history of AD [120, 121]. The ε4 heterozygotes had abnormally low CMRgl in the same regions of posterior cingulate, parietal, temporal, and prefrontal cortex, raising new questions about the earliest brain changes involved in the predisposition to AD, new questions about how these early changes are related to the histopathological and physiological brain changes found at older ages [120], and raising the possibility that brain processes associated with the preredisposition to AD might be targeted by prevention therapies at a particularly young age and a potentially tractable preclinical stage of disease vulnerability.

We have also begun to characterize and compare MRI measurements in our APOE ε4 carriers and noncarriers. Using volumetric MRI's from the 11 ε4 homozygotes and 22 ε4 non-carriers included in our original analysis of PET date, well characterized hippocampal landmarks, and a technique used extensively by Mony deLeon and his colleagues at New York University [85], we investigated the possibility that cognitively normal persons at risk for AD have reductions in hippocampal volume [94]. After normalizing regional measurements for the variation in supratentorial intracranial volume, mean left and right hippocampal volumes were about 8% smaller in the ε4 homozygotes, but did not reach statistical significance. Consistent with other MRI studies, smaller left and right hippocampal volumes in the 33 subjects were each significantly correlated with lower long-term recall scores. As predicted, posterior cingulate CMRgl measurements continued to distinguish ε4 homozygotes from non-carriers after adjusting for left and right hippocampal volumes in a stepwise logistic regression model. In contrast, neither left nor right hippocampal volumes significantly improved the ability to distinguish the ε4 homozygotes and noncarriers in a model already including posterior cingulate glucose metabolism. Thus, using the image-acquisition and image-analysis techniques employed in this study, PET tended to be more sensitive than MRI in identifying cognitively normal persons at risk for AD. While larger samples and longitudinal assessment are required to confirm our conclusions, we suggest that PET measurements of posterior cingulate CMRgl begin to decline prior to the onset of memory decline in persons at risk for AD, and that MRI measurements of hippocampal volume begin to decline some time later, in conjunction with the onset of memory decline and shortly before the onset of AD [94].

It remains possible that other brain regions, other image-analysis strategies, and longitudinal comparisons could be used to detect abnormalities in MRI measurements of brain volume in cognitively normal persons at genetic risk for AD. We recently used VBM (with procedures optimized to remove the influence of non-brain tissue) to investigate regional abnormalities in gray matter density in the 11 ε4 homozygotes, 11 ε4 heterozytotes, and 22 noncarriers included in our original PET studies. An automated algorithm was used to transform the MRI's into the coordinates of a standard brain atlas, correct the images for inhomogeneities, segment them for gray matter, smooth them, and create a statistical map of significant differences in gray matter intensity [104]. A significance threshold of 0.005, uncorrected for multiple comparisons, was used for hypothesized regional effects. In comparison with the ε4 noncarriers, the ε4 homozygotes had significantly lower gray matter densities in the vicinity of the right posterior cingulate cortex, a right peri-hippocampal region, and the left parahippocampal and lingual gyri; and the ε4 heterozygotes had significantly lower gray matter density in the vicinity of the left parahippocampal gyrus, the anterior cingulate cortex, and the right temporal cortex [104]. In comparison with the ε4 heterozygotes, the ε4 homozygotes had significantly lower gray matter density in the vicinity of the left parahippocampal and lingual gyri and in bilateral regions of parietal cortex [104]. Lower measurements of gray matter density in the left parietal and left parahippocampal/lingual areas were correlated with poorer memory scores in the aggregate ε4 carrier group [104]. Thus, cognitively normal ε4 carriers appear to have abnormally low gray matter density in heteromodal association and paralimbic regions that are preferentially affected early in AD. If, as our preliminary findings suggest, reductions in gray matter density are progressive [105], they could help in the efficient evaluation of primary prevention therapies.

Longitudinal Changes

In our first longitudinal comparison, we characterized and compared 2-year CMRgl declines in 10 cognitively normal ε4 heterozygotes and 15 ε4 non-carriers 50-63 years of age with a reported first-degree family history of probable AD and we estimated the power of PET to test the efficacy of treatments to attenuate these declines [8]. There were no significant differences between the subject groups in scores on the MMSE or any of the neuropsychological tests at the time of either scan, no significant declines in these scores between these 2 times in either group, and no significant Group×Time interactions. The ε4 heterozygotes had significant 2-year CMRgl declines in the vicinity of temporal cortex, posterior cingulate cortex, prefrontal cortex, basal forebrain, parahippocampal/lingual gyri, and thalamus, and these declines were significantly greater than those in the ε4 non-carriers [8]. (Like us, Small and his colleagues found 2-year CMRgl declines in their older ε4 carriers with and without a reported family history of probable AD [45].) Although smaller in magnitude, significant declines in posterior cingulate cortex, parietal cortex, anterior cingulate cortex, and the caudate nucleus were found in our group of ε4 noncarriers [8]-apparent physiological markers of normal aging in this age group.

Based on our findings, we have estimated the number of cognitively normal ε4 heterozygotes 50-63 years of age per active and placebo treatment group are needed to detect an attenuation in these CMRgl declines in 1 or 2 years [8] (Table 2). (As a complement to the power estimates provided in our original report, the tables published here include data for different effect sizes, interpolated estimates of the subjects required in a 1-year study, and information about the number of subjects needed to detect an effect in at least one of the implicated regions, [denoted in the table as “combined”].)

In our ongoing longitudinal study, 2-year follow-up studies have currently been performed in 94 of our 47-68 year-old subjects, including (27 ε4 homozygotes, 27 ε4 heterozygotes, and 40 ε4 noncarriers [119]. As in our earlier reports, the ε4 noncarriers had only modest CMRgl declines, and the ε4 carriers had significant CMRgl declines in the vicinity of temporal, posterior cingulate, and prefrontal cortex, basal forebrain, and the thalamus. The CMRgl declines in the temporal and prefrontal cortex in the ε4 carriers were significantly greater than those in the ε4 noncarriers and were significantly correlated with ε4 gene dose. Together, these studies suggest that PET could test the potential efficacy of primary prevention therapies without having to study thousands of research participants, restrict the study to elderly participants, or wait many years to determine whether or when they develop symptoms.

Using both Nick Fox's semi-automated method for the analysis of sequential MRI's using digital subtraction and our fully automated method for analysis of sequential MRI's using IPCA in independent analyses, we have now characterized 2-year rates of whole brain atrophy in 36 cognitively normal subjects from our longitudinal study, including 10 ε4 homozygotes, 10 ε4 heterozygotes, and 16 ε4 noncarriers [100]. Whole brain atrophy rates were significantly correlated with ε4 gene dose and were significantly greater in the homozygotes than in the noncarriers.

Our ongoing longitudinal PET and MRI study of late middle-aged ε4 homozygotes, heterozygotes, and noncarriers is intended to characterize and contrast the trajectory of decline in brain function and structure in cognitively normal persons at differential risk for AD and further establish the role of our brain imaging strategy in the efficient evaluation of primary prevention therapies.

The following is a taxonomy for demonstrating one embodiment of the method of the present invention, including an illustrative set of test conditions:
1.a. A short term decline (for instance, over a period of 6 months to a year) in structural or functional brain imaging results in persons affected by AD predicts further decline in those individuals. That is, not a single baseline measurement, but the measurement in the changes of brain function or structure over a short-term period of time predicts ultimate clinical decline.
1.b. A short term decline in brain imaging measurements in patients with MCI predicts a higher rate of conversion of those patients to AD. These markers of disease progression predict subsequent clinical outcome.
1.c. A two-year decline in imaging measurements in APOE ε4 carriers predicts subsequent clinical decline in MCI and AD.
2.a. Once a candidate disease-slowing treatment has been identified and administered to test subjects, then slowing the short term decline predicts subsequent clinical improvement in AD. Likewise, slowing the short term decline in MCI predicts subsequent rate of conversion to AD.
2.b. If the short term brain changes in AD or MCI-affected patients (or in APOE ε4 carriers) predicts subsequent clinical decline, then a disease slowing treatment in AD and MCI predicts subsequent clinical outcome.

As a result, one embodiment of the method of the present invention provides that sequential longitudinal declines in brain imaging measurements predict subsequent cognitive decline and increased rates of conversion to MCI and probable AD. Likewise, a putative treatment administered to study participants that slows the declines of brain imaging measurements predicts an improved clinical outcome, such as reduced or delayed conversion to MCI or AD. Therefore, using a surrogate marker such as longitudinal brain imaging studies via FDG-PET or volumetric MRI measurement, or a combination of two or more brain imaging data sets processed through a approach such as Partial Least Squares (PLS) analysis, a means is provided to evaluate treatment modalities to prevent or delay the onset of diseases such as MCI or AD, and to evaluate the efficacy of treatments to reduce the effects of aging on the brain in cognitively normal individuals. The efficacy both primary treatments and secondary treatments may be evaluated through sequential imaging surrogate markers; and one resulting treatment goal is that putative primary prevention therapy slows the decline in brain activity.

The surrogate markers identified in the present invention are not limited to FDG PET, volumetric MRI, or combination studies. In alternate embodiment of the present invention, longitudinal amyloid imaging measurements can be used to predict whether a treatment modality will be effective in delaying or preventing the onset of a brain disorder such as MCI or AD. Through administration of an imaging agent or dye such as Pittsburg Compound B combined with imaging via techniques such as PET, time-sequenced imaging studies of the brain produce data indicating rates of plaque accumulation/deposition that may be further used to predict a the likelihood of conversion to MCI or AD in a cognitively normal person at risk for AD. Likewise, the method of the present invention further comprises a method to evaluate primary and secondary putative treatments for brain disorders by monitoring amyloid imaging of treated patients over an interval of time such as six months to a year. If such treated patients show a decline in the rate of plaque deposition, for instance, the putative treatment will be evaluated as positively affecting the clinical progression of AD or MCI.

In an additional aspect of the present invention, if it can be shown that a putative treatment slows the decline in structural or functional brain measurements in cognitively normal persons with other risk factors for AD (e.g. APOE4 non-carriers who have higher cholesterol levels (a possible risk factor) or another susceptibility gene (to be determined), that would support the efficacy and use of the drug in other persons at risk for AD (including those without the APOE ε4 gene).

Linking Functional and Structural Brain Images

In another embodiment of the present invention, the combined use of PET and MRI imaging data can be used to correlate the effects of aging on the brain. Partial least squares linkage between the patterns of reductions of gray matter in MRI and the patterns in glucose metabolism in PET, for instance, provide greater power in testing any change through the combined imaging from two different modalities (e.g. structural via MRI, and functional via FDG PET).

Using Partial Least Squares (PLS) as one of a set of possible multivariate network analysis tools, the present invention utilizes the relation between two (or more) image modalities (i.e., inter-modality) to enhance the ability to detect time- or drug-related effects on the brain by examining the regional covariance between functional and structural neuroimaging datasets.

Linearly combining variables in each of the two datasets to form a new variable (representing all variables in that dataset), PLS can identify newly formed variable pairs (latent variable pair), one from each dataset, that has maximal covariance. More generally, PLS can identify a series of paired latent variables such that the covariance of the kth pair is the kth largest among all possible pairs between the two datasets. Note that PLS maximizes covariance, not the correlation coefficient.

To perform this computationally intensive multivariate analysis, we developed a strategy to utilize submatrix operations that make the computation of high dimensional datasets with covariance analysis using multivariate methods, such as PLS, feasible.

In one approach, image pre-processing was performed using SPM99 (Wellcome Department of Cognitive Neurology, London). Improved procedures were used to optimize image segmentation and spatial normalization (i.e., discounting the effects of non-brain tissue when generating gray tissue probability maps in the coordinates of the Montreal Neurological Institute [MNI] brain template). The MRI gray tissue maps were re-sampled into 26 slices each is a 65×87 matrix of 2×2×4 mm voxels. A common mask was generated such that voxels in this mask had 20% or higher gray matter concentration for all subjects. PET data were also transformed into the MNI coordinates using the same image dimensions and the common mask created above. Finally, MRI/PET images were smoothed to final compatible resolutions. After pre-processing individual images, PET and MRI data matrix, X and Y, were formed. X and Y all have n rows, one for each subject. The i^{th} row of the matrix X (Y) represents the 3D MRI (PET) data for subject i in the form of a row vector; and j^{th} column consists the data from voxel j. Global mean PET/MRI measurements were statistically removed on a voxel basis using analysis of covariance. In addition, X and Y were standardized (i.e., such that mean=0 and STD=1).

The square root of the largest eigenvalue of the matrix Ω=[X′YY′X] corresponds to the largest covariance among all possible latent variable pairs between X and Y. The latent variable t of X is expressed as t=Σwᵢxᵢ where (w₁ w₂ . . . w_{Kx})′ is the column eigenvector of Ω, and x is the i^{th} column of X. The corresponding latent variable u of Y is formed similarly. The second largest covariance can be obtained by first regressing t out of X and u out of Y, and then repeating the above procedure using the residual matrices. The same iteration procedure also works for the 3^{rd} largest covariance etc. Subsequent statistical analysis of the PLS results (the latent variable pair [its value for each subject is referred to as subject scores below] and the associated covariance) is an important part of the PLS analysis and requires more dedicated tools (such as non-parametric permutation tests). In one embodiment, the subject score pair was examined by linear regression and used to check their power to distinguish the young adult group from the older group. The latent variables were mapped back to MRI space (singular images) for visual inspection.

In one embodiment of the present invention, to make the computation possible for a high-dimensional data matrix, we adopted the following strategy: a), we reduced the number of voxels by re-sampling the image data with larger voxel size; b) we partitioned each of the matrices into a series of small matrices; saved the small matrices on the hard disk (16 bits with scaling factor); only read one sub-matrix at a time into memory; and saved the calculated results back to the hard disk as a sub-matrix. To make this strategy work, we only used matrix operations that can act separately on sub-matrices and result in a sub-matrix form; c) we adopted a power iterative algorithm for computing latent variables. The only operations in each iteration are matrix-by-vector/scalar multiplications.

In a preliminary cross-sectional study, PLS was used to investigate the regional covariance between functional and structural brain imaging data from cognitively normal 15 younger (31.3±4.8 years old) and 14 older (70.7±3.5 years old) volunteers. ¹⁸F-fluorodeoxyglucose (FDG) PET and volumetric T₁-weighted MRI data were acquired in each subject with his/her informed consent, and under guidelines approved by human-subjects committees at Good Samaritan Medical Center and the Mayo Clinic. PET was performed with the 951/31 ECAT scanner (Siemens, Knoxville, Tenn.) as the subjects, who had fasted for at least 4 hours, lay quietly in a darkened room with their eyes closed and directed forward. MRI data was acquired using a 1.5 T Signa system (General Electric, Milwaukee, Wis.) and T₁-weighted, 3D pulse sequence (radio-frequency-spoiled gradient recall acquisition) in the steady state. The pooled data from the younger and older subjects was analyzed by PLS without reference to the group age difference.

For the datasets used in this application, the computation of the first singular image pair took approximately 96 hours for a covariance matrix of 45,666 by 45,666. The PLS algorithm was implemented in MATLAB (MathWorks, MA) on an XP1000 Alpha station.

The PET and MRI subject scores were closely correlated (R=0.84, p<7.2e-09). As indicated in FIG. 1, there was no overlap between the younger (diamonds) and older subjects (circles) using the combination of PET and MRI scores and, indeed, the combination of scores maximized the group separation.

Turning to FIG. 2, the first singular PET (left) and MRI images. Reduced cerebral metabolic rate for glucose (CMRgl) and gray matter concentration were each observed in the vicinity of medial frontal, anterior cingulate, bilateral superior frontal and precuneus cortex; lower CMRgl was observed in the absence of lower gray matter concentration in the vicinity of the posterior cingulate and bilateral inferior frontal cortex; and measurements of CMRgl and gray matter concentration were each relatively preserved in the vicinity of occipital cortex and the caudate nucleus. Analyzing the paired PET and MRI images from normal older and younger adults, the PLS method revealed a regional pattern of association between brain function and brain structure that differed as a function of normal aging.

In a preliminary cross-sectional study, we characterized the regional covariance or linkage between cerebral metabolic and gray matter patterns that best accounted for differences in brain function and structure related to normal aging. The disclosed PLS method facilitates the investigation of relationships between brain function and brain structure, providing increased power in the diagnosis, early detection, and tracking of disease-related brain changes and providing increased power in the evaluation of a candidate treatments' disease-modifying effects.

Given the above, the invention may be further characterized as a method for evaluating of a treatment to decrease the risk of a progressive brain disorder or to slow brain aging. For real persons at risk for Alzheimer's disease, a neurodegenerative disease, or brain aging, a measurement's rate of change can be characterized during or following the real persons' treatment with disease-preventing or neurological age-slowing therapy. For hypothetical persons similar to the real persons at risk for these conditions but who are not so treated, the measurement's rate of change can be characterized over a like time interval. The disease-preventing or age-slowing therapy's efficacy is suggested by a smaller measurement rate of change over the like time interval in the real persons treated than in the hypothetical persons not so treated, even in the absence of clinical decline over the time interval. Measurements of neurodegenerative disease progression will have significantly higher rates of change in persons clinically affected by or at risk for the disease than in those persons at lower risk for the neurodegenerative disease.

The treatment being evaluated can be putative AD prevention therapy, putative neurodegenerative disease prevention therapy, a putative therapy to slow an aspect of brain aging, or a combination of the foregoing. These therapies, and methods for their evaluation, are discussed below.

Evaluation of An AD Prevention Therapy

To evaluate an AD prevention therapy, one or more measurements are taken in real persons at two or more different times each of which is found in the absence of treatment to be associated with statistically significant (i) rates of change in AD patients, or (ii) greater rates of change in MCI patients who subsequently show further cognitive decline than in MCI patients who do not, or (iii) greater rates of change in persons thought to be at higher AD risk that are cognitively normal or not disabled by AD than persons thought to be at lower AD risk that are cognitively normal or not disabled by AD.

A method can use the measurements with respect to real persons who have an AD risk factor but do not have clinically significant cognitive impairment. The method has a step that characterizes the rate of change in each measurement over a time period during or following the real persons' treatment with a putative AD prevention therapy.

For hypothetical persons who are similar to the real persons in their risk for AD, age, and absence of clinically significant cognitive impairment but who are not treated with the putative AD prevention therapy, the method has a step that characterizes the rate of change in the same measurement over a like time interval.

From the foregoing method steps, the efficacy of the putative AD prevention therapy is suggested by a finding of a statistically smaller rate of change in each measurement over the like time interval for the real persons treated with the putative AD prevention therapy than in the hypothetical persons that are not treated with the putative AD prevention therapy.

Each of the measurements can be a brain imaging measurement, an electrophysiological measurement, a biochemical measurement, a molecular measurement, a transcriptomic measurement, a proteomic measurement, a cognitive measurement, a behavior measurement, or a combination of the foregoing.

One of the measurements can be the cerebral metabolic rate for glucose (CMRgl) in brain regions found to have a greater rate of CMRgl decline in cognitively normal persons at higher risk for AD than in those with a lower risk. Here, the CMRgl is measured using fluorodeoxyglucose (FDG) positron emission tomography (PET), where the real and hypothetical persons each have at least one copy of the APOE ε4 allele.

Each measurement can be the rate of change in brain tissue volume or the rate of change in cerebrospinal fluid volume so as to provide information about the rate of brain atrophy. The brain tissue volume or the cerebrospinal fluid volume can be measured using magnetic resonance imaging (MRI). In such cases, the real and hypothetical persons will preferably have at least one copy of the APOE ε4 allele.

In one embodiment, each of the measurements is suggested to provide an indirect assessment of the progression of AD pathology, where the AD pathology can be the loss of intact neurons or synapses, the formation of amyliod plaques, the formation of neurofibrillary tangles, or a combination of the foregoing.

Each measurement can be a concentration of amyloid proteins, a concentration of amyloid oligimers, a concentration of amyloid plaques, a concentration of tau, a concentration of phosphorylated tau proteins, a concentration of tangles, a concentration of F2-isoprostanes, a concentration of lipid peroxidation, a concentration of inflammatory, activated microglial, a molecular immune change, and a molecular change associated with the progression of AD. Each measurement can be a reflection of the activity or integrity of brain cells, a reflection of the activity or integrity of white matter tracks, or a combination of the foregoing. Each measurement can be a neurotransmitter characteristic, a neuroreceptor characteristic, a neurochemical characteristic, a molecular characteristic, a physiological characteristic, or a combination of the foregoing. Each measurement can be made by a brain imaging technique, a biological assay, and combination of the foregoing. Here, the biological assay can be performed using a sample that is a body fluid, cerebrospinal fluid, blood, saliva, urine, a body tissue. Here, the brain imaging technique can be different PET and single photon emission tomography radiotracer methods, a structural, functional, perfusion-weighted, or diffusion-weighted MRI, x-ray computed tomography, magnetic resonance spectroscopy measurements of N-acetyl aspartic acid, myoinositol, and other chemical compounds, electroencephalography, quantitative electroencephalography, event-related potentials, other electrophysiological procedures, magnetoencephalography, an electrophysiological method, or a combination of the foregoing.

The AD risk factor can be a genetic risk factor, a non-genetic risk factor, or a combination of the foregoing. The genetic risk factor can be the presence of 1 or 2 copies of the APOE E4 allele, the presence of other confirmed susceptibility genes, the presence of a presenilin 1 mutation, presenilin 2 mutation, amyloid precursor protein mutation, or other mutations or gene shown to cause AD, an aggregate genetic risk score that is based upon a person's number of susceptibility genes and their individual contribution to an AD risk, a family history of AD, or a combination of the foregoing. The non-genetic risk factor can be head trauma associated with loss of consciousness, a higher than normal cholesterol level, a higher than normal homocysteine level, a brain imaging measurement thought to be associated with a higher than normal risk of subsequent cognitive decline, MCI, or AD, being at least 60 years of age, a biological marker associated with a higher that normal risk of subsequent cognitive decline, MCI, or AD, a cognitive measurement thought to be associated with a higher than normal risk of subsequent cognitive decline, MCI, or AD, a behavioral measurement thought to be associated with a higher than normal risk of subsequent cognitive decline, MCI, or AD, or a combination of the foregoing.

The validity of each measurement as a “therapeutic surrogate” will preferably be further supported to suggest the efficacy of the putative AD prevention therapy by a statistically significant relationship between rates of change in each measurement over the like time interval and subsequent clinical decline in patients with AD or MCI or in cognitively normal or non-disabled persons at AD risk. Further, the validity of each measurement as a “therapeutic surrogate” will preferably be further supported to suggest the efficacy of the putative AD prevention therapy by a statistically significant showing of how the ability of the putative AD prevention therapy to slow the rate of change in each said measurement over the like time interval is associated with slower rates of subsequent clinical decline in patients with AD or MCI or in cognitively normal or non-disabled persons at AD risk.

The putative AD prevention therapy can be a pharmacological prescription, an over-the-counter medication, an immunization therapy, a biological therapeutic, a dietary supplement, a dietary change, a physical exercise, a mental exercise, a lifestyle change intended to promote healthy living, decrease the risk of cognitive decline, MCI, AD, or cardiovascular disease, or a combination of the foregoing. Note that the putative therapy can be applied to a patient who has AD, MCI, or is a cognitively normal or non-disabled person who has an AD risk factor.

Evaluation of A Neurodegenerative Disease Prevention Therapy

To evaluate a neurodegenerative disease prevention therapy, one or more measurements are taken in real persons at two or more different times, each of which is found in the absence of treatment to be associated with statistically significant (i) rates of change in patients having a neurodegenerative disease or (ii) greater rates of change in persons at higher risk for the neurodegenerative disease but not disabled by the neurodegenerative disease than those in persons at lower risk for the neurodegenerative disease.

A method can use the measurements with respect to the real persons who have a neurodegenerative disease risk factor but do not have clinically significant neurological impairment. The method has a step that characterizes the rate of change in each measurement over a time period during or following the real persons' treatment with a putative neurodegenerative disease prevention therapy.

For hypothetical persons who are similar to the real persons in their risk for the neurodegenerative disease, age, and absence of clinically significant cognitive impairment but who are not treated with the putative neurodegenerative disease prevention therapy, the method has a step that characterizes the rate of change in the same measurement over a like time interval.

From the foregoing method steps, the efficacy of the putative neurodegenerative disease prevention therapy is suggested by a finding of a statically smaller rate of change in each measurement over the like time interval for the real persons treated with the putative neurodegenerative disease prevention therapy than in the hypothetical persons that are not treated with the putative neurodegenerative disease prevention therapy.

The neurodegenerative disease can be Alzheimer's disease, Dementia with Lewy Bodies, Parkinson's disease, Parkinson's dementia, a frontotemporal dementia, a tauopathy, other progressive dementias, amyotropic lateral sclerosis, other progressive neuromuscular disorders, multiple sclerosis, other progressive neuroimmunological disorders, Huntington's disease, a focal or generalized brain disorder which involves a progressive loss of brain function over time, or a combination of the foregoing.

Each repeated measurement can be a brain imaging measurement, an electrophysiological measurement, a biochemical measurement, a molecular measurement, a transcriptomic measurement, a proteomic measurement, a cognitive measurement, a behavior measurement, or a combination of the foregoing.

One of the measurements can be the cerebral metabolic rate for glucose (CMRgl) in brain regions found to have a greater rate of CMRgl decline in patients with Parkinson's disease patients who subsequently development Parkinson's dementia than in Parkinson's patients who do not subsequently develop Parkinson's dementia. Here, the CMRgl is measured using fluorodeoxyglucose (FDG) positron emission tomography (PET). Preferably, the real and hypothetical persons each have Parkinson's disease but do not have dementia at the beginning of the like time interval.

Each of the measurements can be a brain imaging measurement, an electrophysiological measurement, or a combination of the foregoing. Each measurement can be a biochemical assay, a molecular assay, or a combination of the foregoing. In one implementation, at least one of the measurements will preferably have a greater rate of change in persons at a higher risk for the neurodegeneragive disease that in persons at a lower risk for the neurodegeneragive disease in the absence of disabling symptoms of the neurodegeneragive disease.

The validity of each measurement as a “therapeutic surrogate” will preferably be further supported to suggest the efficacy of the putative neurodegenerative disease prevention therapy by a statistically significant relationship between rates of change in each said measurement over the like time interval and subsequent clinical decline in patients affected by or at risk for the neurodegenerative disease. Moreover, the validity of each measurement as a “therapeutic surrogate” will further be supported to suggest the efficacy of the putative neurodegenerative disease prevention therapy by a statistically significant showing of how the ability of the putative neurodegenerative disease prevention therapy to slow the rate of change in each said measurement over the like time interval is associated with slower rates of subsequent clinical decline in patients affected by or at risk for the neurodegenerative disease.

The putative neurodegenerative disease prevention therapy can be a pharmacological prescription, an over-the-counter medication, an immunization therapy, a biological therapeutic, a dietary supplement, a dietary change, a physical exercise, a mental exercise, a lifestyle change intended to promote healthy living, reduced the risk of the neurodegenerative disorder or its symptoms, or reduce the risk of cardiovasculare disease, or a combination of the foregoing. The person being treated with the neurodegenerative disease prevention therapy can have a neurodegenerative disease or can be a person without disabling symptoms of a neurodegenerative disease who has a neurodegenerative disease risk factor.

Evaluation of a Therapy to Slow An Aspect of Brain Aging

To evaluate a putative therapy to slow an aspect of brain aging, one or more measurements are taken in real persons at two or more different times. These measurements will preferably be found in the absence of treatment to be associated with statistically significant rates of change associated with aging in patients who do not have clinical signs or symptoms of a progressive brain disorder.

A method can use the measurements with respect to the real persons who do not have clinical signs or symptoms of a progressive brain disorder. The method has a step that characterizes the rate of change in each measurement over a time period during or following the real persons' treatment with a putative therapy to slow an aspect of brain aging;

For hypothetical persons who are similar to the real persons their age and absence of clinically significant signs of symptoms of a brain disorder but who are not treated with the putative therapy to slow an aspect of brain aging, the method has a step that characterizes the rate of change in the same measurement over a like time interval.

From the foregoing method steps, the efficacy of the putative therapy to slow an aspect of brain aging is suggested by a finding of a statistically smaller rate of change in each said measurement over the like time interval for the real persons treated with the putative therapy to slow an aspect of brain aging than in the hypothetical persons that are not treated with the putative therapy to slow an aspect of brain aging. When the therapy is effective in slowing down an aspect of brain aging, there could be a delay in the onset of disorders that are caused in part by those aging changes and there could be a slower decline in cognitive or neurological abilities that are adversely affected by those aging changes.

One of the measurements can be the cerebral metabolic rate for glucose (CMRgl) in brain regions found to be affected by normal aging, healthy aging, or very health aging. Here, the CMRgl is measured using fluorodeoxyglucose (FDG) positron emission tomography (PET).

“Normal aging” can be characterized by the absence of a brain disorder of the absence of a medical problem that could affect the brain. “Healthy aging” can be further characterized by the absence of any signs or symptoms of an age-related brain disorder. “Very health aging” can be further characterized by the absence of one or more known risk factors for an age-related disorder. For instance, a risk factor can be having a copy of the APOE ε4 allele.

One of the measurements can be a brain imaging measurement, an electrophysiological measurement, or a combination of the foregoing. Each measurement can be a biochemical assay, a molecular assay, a measurement of oxidative stress, or a combination of the foregoing.

The validity of each measurement as a “therapeutic surrogate” will preferably be further supported to suggest the efficacy of the putative therapy to slow an aspect of brain aging by a statistically significant showing that the rate of change in each said measurement over the like time interval is predictive of an age-related cognitive decline or a behavioral decline. Further, the validity of each measurement as a “therapeutic surrogate” will preferably be further supported to suggest the efficacy of the putative therapy to slow an aspect of brain aging by a statistically significant showing that the rate of change in each measurement over the like time interval is predictive of a subsequent age-related decline in cognitive, behavioral, or other neurological abilities. Still further, the validity of each measurement as a “therapeutic surrogate” will preferably be further supported to suggest the efficacy of the putative therapy to slow an aspect of brain aging by a statistically significant showing that the rate of change in each said measurement over the like time interval is predictive of one or more age-related disorders that are more likely to be found in aged individuals. In addition, the validity of each measurement as a “therapeutic surrogate” will preferably be further supported to suggest the efficacy of the putative therapy to slow an aspect of brain aging by a statistically significant showing that the rate of change in each measurement over the like time interval is associated with slower rates of age-related cognitive decline, age-related behavioral decline, other age-related neurological, neuropsychological, or psychiatric declines, or the onset of an age-related disorder.

The putative therapy to slow an aspect of brain aging can be a pharmacological prescription, an over-the-counter medication, an immunization therapy, a biological therapeutic, a dietary supplement, a dietary change, a physical exercise, a mental exercise, a lifestyle change intended to promote healthy living, a lifestyle change intended to promote healthy mental function, a lifestyle change intended to decrease a risk of cardiovascular disease, or a combination of the foregoing. The person being treated with the putative therapy may or may not have an age-related disorder and may or may not have a risk factor for an age-related disorder.

While preferred embodiments of this invention have been shown and described, modifications thereof can be made by one skilled in the art without departing from the spirit or teaching of this invention. The embodiments described herein are exemplary only and are not limiting. Many variations and modifications of the method and any apparatus are possible and are within the scope of the invention. One of ordinary skill in the art will recognize that the process just described may easily have steps added, taken away, or modified without departing from the principles of the present invention. Accordingly, the scope of protection is not limited to the embodiments described herein, but is only limited by the claims that follow, the scope of which shall include all equivalents of the subject matter of the claims.

### NUMBERED REFERENCES

1. McKhann G, Drachman D, Folstein M, Katzman R, Price D, Stadlan E M. Clinical diagnosis of Alzheimer's disease: report of the NINCDS-ADRDA Work Group under the auspices of the Department of Health and Human Services Task Force on Alzheimer's Disease. Neurology 1984; 34:939-944.
2. American Psychiatric Association. Diagnostic and statistical manual of mental disorders. 4th ed. Washington, D.C.: American Psychiatric Association, 1994.
3. Reiman E M, Caselli R J. Alzheimer's Disease. Maturitas 1999; 31:185-200.
4. Terry R D, Maskiah E, Hansen L A. The neuropathology of Alzheimer disease and the structural basis of its cognitive alterations. In: Terry R D, Katzman R, Bick K L, and Sisodia S S, eds. Alzheimer Disease, 2nd Ed. Philadelphia: Lippincott Williams & Wilkins, 1999; 187-206.
5. Cohen D, Eisdorfer C. Depression in family members caring for a relative with Alzheimer's disease. J Am Geriatr Soc 1988; 36:885-889.
6. Evans D A, Funkenstein H H, Albert M S, et al. Prevalence of Alzheimer's disease in a community population of older persons: higher than previously reported. JAMA 1989; 262: 2551-2556.
7. Katzman R, Kawas C. The epidemiology of dementia and Alzheimer disease. In: Terry R D, Katzman R, and Bick K L, eds. Alzheimer Disease. New York: Raven Press, 1994; 105-122.
8. Reiman E M, Caselli R J, Chen K, et al. Declining brain activity in cognitively normal apolipoprotein E ε4 heterozygotes: a foundation for testing Alzheimer's prevention therapies. Proc Natl Acad Sci USA 2001; 98:3334-3339.
9. Reiman E M, Caselli R J, Alexander G E, Chen, K. Tracking the decline in cerebral glucose metabolism in persons and laboratory animals at genetic risk for Alzheimer's disease. Clinical Neuroscience Research 2001; 1:194-206.
10. Khachaturian, Z S. The five-five, ten-ten plan for Alzheimer's disease (editorial). Neurobiol Aging 1992; 13:197-198.
11. Petersen R C, Smith G E, Waring S C, Ivnik, R J, Tangalos E G, Kokmen E. Mild cognitive impairment: clinical characterization and outcome. Arch Neurol. 1999; 56:303-308.
12. Morris J C, Storandt M, Miller J P, et al. Mild cognitive impairment represents early-stage Alzheimer disease. Arch Neurol 2001; 58:397-405.
13. Seshadri, S, et al. Plasma Homocysteine as a Risk Factor for Dementia and Alzheimer's Disease. New Engl J Med; 346: 476-483.
14. Snowdon D A, Tully C L, Smith C D, Riley K P, Markesbery W R. Serum folate and the severity of atrophy of the neocortex in Alzheimer disease: findings from the nun study. Am J Clin Nutr 2000; 71:993-998.
15. Strittmatter W J, Weisgraber K H, Huang D Y, et al. Binding of human apolipoprotein E to synthetic amyloid β peptide isoform-specific effects and implications for late-onset Alzheimer disease. Proc Natl Acad Sci USA 1993; 90:98-8102.
16. Saunders A M, Strittmatter W J, Schmechel D, et al. Association of apolipoprotein E allele ε4 with late-onset familial and sporadic Alzheimer's disease. Neurology 1993; 43:1467-1472.
17. Corder E H, Saunders A M, Strittmatter W J, et al. Gene dose of apolipoprotein E type 4 allele and the risk of Alzheimer's disease in late onset families. Science 1993; 261:921-924.
18. Farrer L A, Cupples L A, Haines J L, Hyman B, Kukull W A, Mayeux R, Myers R H, Pericak-Vance M A, Risch N, van Duijn C M. Effects of age, sex, and ethnicity on the association between apolipoprotein E genotype and Alzheimer disease. A meta-analysis. APOE and Alzheimer Disease Meta Analysis Consortium. JAMA 1997; 278(16):1349-56.
19. Wisniewski T, Castano E M, Golabek A, et al. Acceleration of Alzheimer's Fibril formation by apolipoprotein E in vitro. Am J Pathol 1994; 145:1030-1035.
20. Miyata M, Smith J D. Apolipoprotein E allele-specific antioxidant activity and effects on cytotoxicity by oxidative insults and bamyloid peptides. Nat Genet 1996; 14:55-61.
21. Strittmatter W J, Weisgraber K H, Goedert M, et al. Hypothesis: microtubule instability and paired helical filament formation in the Alzheimer disease brain are related to apolipoprotein E genotype. Exp Neurol 1994; 125:163-171.
22. Mahley R W. Apolipoprotein E: cholesterol transport protein with expanding role in cell biology. Science 1988; 240:622-30.
23. Corder E H, Saunders A M, Risch N J, et al. Protective effect of apolipoprotein E type 2 allele for late onset Alzheimer disease. Nature Genetics 1994; 7:180-184.
24. Saunders A M, Hulette C, Welsh-Bohmer K A, et al. Specificity, sensitivity, and predictive value of apolipoprotein-E genotyping for sporadic Alzheimer's disease. Lancet 1996; 348:90-93.
25. de Leon M J, Ferris S H, George A E, et al. Computed tomography and positron emission transaxial evaluations of normal aging and Alzheimer's disease. J Cereb Blood Flow Metab 1983; 3:391-394.
26. Foster N L, Chase T N, Fedio P, et al. Alzheimer's disease: Focal cortical changes shown by positron emission tomography. Neurology 1983; 33:961-965.
27. Duara R, Grady C L, Haxby J V, et al. Positron emission tomography in Alzheimer's disease. Neurology 1986; 36:879-887.
28. Jagust W J, Friedland R P, Budinger T F, et al. Longitudinal studies of regional cerebral metabolism in Alzheimer's disease. Neurology 1988; 38:909-912.
29. Haxby J V, Grady C L, Koss E, et al. Longitudinal study of cerebral metabolic asymmetries and associated neuropsychological patterns in early dementia of the Alzheimer type. Arch Neurol 1990; 47:753-760.
30. McGeer E G, Peppard R P, McGeer P L, et al. 18 Fluorodeoxyglucose positron emission tomography studies in presumed Alzheimer cases, including 13 serial scans. Can J Neurol Sci 1990; 17:1-11.
31. Smith G S, de Leon M J, George A E, et al. Topography of cross-sectional and longitudinal glucose metabolic defecits in Alzheimer's disease. Pathophysiologic implications. Arch Neurol 1992; 49:1142-1150.
32. Minoshima S, Foster N L, Kuhl D E. Posterior cingulate cortex in Alzheimer's disease. Lancet 1994; 344:895.
33. Mielke R, Herholz K, Grond M. Clinical deterioration in probable Alzheimer's disease correlates with progressive metabolic impairment of association areas. Dementia 1994; 5:36-41.
34. Minoshima S, Frey K A, Koeppe R A, et al., A diagnostic approach in Alzheimer's disease using three-dimensional stereotactic surface projections of fluorine-18-FDG PET. J Nucl Med 1995; 36:1238-48.
35. Mega M S, Chen S S, Thompson P M, et al. Mapping histology to metabolism: coregistration of stained whole-brain sections to premortem PET in Alzheimer's disease. Neuroimage 1997; 5:147-153.
36. Pietrini P, Alexander G E, et al. Abnormal metabolic patterns in Alzheimer's disease after correction for partial volume effects. Neurology 1998; 50:1585-1593.
37. Hoffman J M, Welsh-Bohmer K A, Hanson M, et al. FDG PET imaging in patients with pathologically verified dementia. J Nucl Med 2000; 41:1920-1928.
38. Silverman D H, Small G W, Chang C Y, et al. Positron emission tomography in evaluation of dementia: Regional brain metabolism and long-term outcome. JAMA 2001; 286; 17:2120-7.
39. Alexander G E, Chen K, Pietrini P, Rapoport S I, Reiman E M. Longitudinal PET evaluation of cerebral metabolic decline in dementia: a potential outcome measure in Alzheimer's disease treatment studies. Am J Psychiatry 159:738-745, 2002.
40. Schwartz W I, Smith C B, Davidsen L, et al. Metabolic mapping of functional activity in the hypothalamic neurohypophysial system of the rat. Science 1979;205:723-725.
41. Meguro K, Blaizot X, Kondoh Y, et al. Neocortical and hippocampal glucose hypometabolism following neurotoxic lesions of the entorhinal and perirhinal cortices in the non-human primate as shown by PET. Implications for Alzheimer's disease. Brain 1999; 122:1519-31.
42. Magistretti P J and Pellerin L. Cellular bases of brain energy metabolism and their relevance to functional brain imaging: evidence for a prominent role of astrocytes. Cereb Cortex 1996; 6:50-61.
43. Piert M, Koeppe R A, Giordani B, et al. Diminished glucose transport and phosphorylation in Alzheimer's disease determined by dynamic FDG-PET. J Nucl Med 1996; 37:201-8.
44. Mark R J, Pang Z, Geddes J W, et al. Amyloid β-Peptide Impairs Glucose Transport in Hippocampal and Cortical Neurons: Involvement of Membrane Lipid Peroxidation. J Neurosci 1997; 17:1046-54.
45. Small G W, Mazziotta J C, Collins M T, et al. Apolipoprotein E type 4 allele and cerebral glucose metabolism in relatives at risk for familial Alzheimer disease. J Am Med Assoc 1995; 273:942-947.
46. Reiman E M, Caselli R J, Yun L S, et al. Preclinical evidence of a genetic risk factor for Alzheimer's disease in apolipoprotein E type 4 homozygotes using positron emission tomography. N Engl J Med 1996; 334:752-758.
47. Small G W, Ercoli L M, Silverman D H S, et al. Cerebral metabolic and cognitive decline in persons at genetic risk for Alzheimer's disease. Proc Natl Acad Sci USA 2000; 97: 6037-6042.
48. Mielke R, Zerres K, Uhlhaas S, et al. Apolipoprotein E polymorphism influences the cerebral metabolic pattern in Alzheimer's disease. Neurosci Lett 1998; 254:49-52.
49. Higuchi M, Arai H, Nakagawa T, et al. Regional cerebral glucose utilization is modulated by the dosage of apolipoprotein E type 4 allele and alpha1-antichymotrypsin type A allele in Alzheimer's disease. Neuroreport 1997; 8:2639-43.
50. Corder E H, Jelic V, Basun H, et al. No difference in cerebral glucose metabolism in patients with Alzheimer disease and differing apolipoprotein E genotypes. Arch Neurol 1997; 54:273-7.
51. Hirono N, Mori E, Yasuda M, et al. Lack of association of apolipoprotein E epsilon 4 allele dose with cerebral glucose metabolism in Alzheimer disease. Alzheimer Dis Assoc Disord 1998; 12:362-7.
52. Kuhl D E, Koeppe R A, Minoshima S, et al. In vivo mapping of cerebral acetylcholinesterase activity in aging and Alzheimer's disease. Neurology. 1999; 52:691-9.
53. Cagnin A, Brooks D J, Kennedy A M, et al. In-vivo measurement of activated microglia in dementia. Lancet. 2001; 358:461-7.
54. Mathis C A, Bacskai B J, Kajdasz S T, et al. A lipophilic thioflavin-T derivative for positron emission tomography (PET) imaging of amyloid in brain. Biorg Med Chem Lett 2002; 12:295-8.
55. Shoghi-Jadid K, Small G W, Agdeppa E D, et al. Localization of neurofibrillary tangles (NFTs) and beta-amyloid placques (APs) in the brains of living patients with Alzheimer's disease. Am J Geriatr Psychiatry 2002; 10:24-35.
56. Seab J, Jagust W, Wong S, et al. Quantitative NMR measurements of hippocampal atrophy in Alzheimer's disease. Magn Reson Med 1988; 8:200-208.
57. Jack C R, Petersen R C, O'Brien P C, Tangalos E G. MR-based hippocampal volumetry in the diagnosis of Alzheimer's disease. Neurology 1992; 42:183-188.
58. Golomb J, de Leon M J, Kluger A, et al. Hippocampal atrophy in normal aging—an association with recent memory impairment. Arch Neurol 1993; 50:967-973.
59. de Leon M J, George A E, Stylopoulos L A, Smith G, Miller D C. Early marker for Alzheimer's disease: the atrophic hippocampus. Lancet 1989; 672-673.
60. Kesslak J, Nalcioglu O, Cotman C. Quantification of magnetic resonance scans for hippocampal and parahippocampal atrophy in Alzheimer's disease. Neurology 1991; 41:51-54.
61. Rusinek H, de Leon M, George A, et al. Alzeimer disease: measuring loss of cerebral gray matter with MRI imaging. Radiology 1991; 178:109-114
62. Killiany R, Moss M, Albert M, Tamas S. Temporal lobe regions on magnetic resonance imaging identify patients with early Alzheimer's disease. Arch Neurol 1993; 50:949-954.
63. Lehericy S, Baulac M, Chiras J, et al. Amygdalohippocampal MR volume measurements in the early states of Alzheimer disease. Am J Neuroradiol 1994; 15:927-937.
64. Deweer B, Lehericy S, Pillon B, et al. Memory disorders in probable Alzheimer's disease: the role of hippocampal atrophy as shown with MRI. J Neurol Neurosurg Psychiatry 1995; 58:590-597.
65. Laakso M, Partanen K, Riekkinen P, et al. Hippocampal volumes in Alzheimer's disease, Parkinson's disease with and without dementia, and in vascular dementia: an MRI study. Neurology 1996; 46:678-681.
66. de Leon M J, Golomb J, George A E, et al. The radiologic prediction of Alzheimer's disease: the atrophic hippocampal formation. Am J Neuroradiol 1993; 14:897-906.
67. Krasuski J S, Alexander G E, Horwitz B, et al. Volumes of medial temporal lobe structure in patients with Alzheimer's disease and mild cognitive impairment (and in healthy controls). Biol Psychiatry 1998; 43:60-9.
68. Juottonen K, Laakso M P, Partanen K, et al. Comparative MR analysis of the entorhinal cortex and hippocampus in diagnosing Alzheimer disease. AJNR Am J Neuroradiol 1999; 20:139-44.
69. Jack C R Jr, Petersen R C, Xu Y, et al. Rate of medial temporal lobe atrophy in typical aging and Alzheimer's disease. Neurology 1998; 51:993-9.
70. Laakso M P, Soininen H, Partanen K, et al. Volumes of hippocampus, amygdala and frontal lobes in the MRI-based diagnosis of early Alzheimer's disease: correlation with memory functions. J Neural Transm Park Dis Dement Sect 1995; 9:73-86.
71. Schuv N, Amend D, Ezekiel F, et al. Change of hippocampal N-acetyl aspartate and volume in Alzheimer's disease. Neurology 1997; 49:1513-21.
72. Jack C R Jr, Petersen R C, Xu Y C, et al. Medial temporal atrophy on MRI in normal aging and very mild Alzheimer's disease. Neurology 1997; 49:786-94.
73. Frisoni G B, Laakso M P, Beltramello A, et al. Hippocampal and entorhinal cortex atrophy in frontotemporal dementia and Alzheimer's disease. Neurology 1999; 52:91-100.
74. Juottonen K, Laakso M P, Insausti R, et al. Volumes of the entorhinal and perirhinal cortices in Alzheimer's disease. Neurobiol Aging 1998; 19:15-22.
75. Bobinski M, de Leon M J, Convit A, et al. MRI of entorhinal cortex in mild Alzheimer's disease. Lancet 1999; 353:38-40.
76. Xu Y, Jack C R Jr, O'Brien P C, et al. Usefulness of MRI measures of entorhinal cortex versus hippocampus in A D. Neurology, 2000; 54: 1760-7.
77. Jack C R, Jr., Petersen R C, Xu Y, O'Brien P C, Smith G E, Ivnik R J, et al. Rates of hippocampal atrophy correlate with change in clinical status in aging and A D. Neurology 2000; 55(4):484-489.
78. Visser P J, Scheltens P, Verhey F R, et al. Medial temporal lobe atrophy and memory dysfunction as predictors for dementia in subjects with mild cognitive impairment. J Neurol 1999; 246:477-85.
79. Du A T, Schuff N, Zhu X P, et al. Atrophy rates of entorhinal cortex in AD and normal aging. Neurology 2003; 60:481-6.
80. Du A T, Schuff N, Kramer J H, et al. Higher atrophy rate of entorhinal cortex than hippocampus in Alzheimer's disease. Neurology 2003 (in press).
81. Fox N C, Freeborough P A, Rossor M N. Visualization and quantification of rates of atrophy in Alzheimer's disease. Lancet 1996; 348:94-97.
82. Freebourough P A, Fox N C. The boundry shift integral: an accurate and robust measure of cerebral volume changes from registered repeat MRI. IEEE Trans Med Imaging 1997; 16:623-629.
83. Fox N C, Freeborough P A. Brain atrophy progression measured from registered serial MRI. J Magn Reson Imaging 1997; 7:1069-1075.
84. Fox N C, Cousens S, Scahill R, et al. Using serial registered brain magnetic resonance imaging to measure disease progression in Alzheimer disease: power calculations and estimates of sample size to detect treatment effects. Arch Neurol 2000:57:333-444.
85. Fox N C, Crum W R, Scahill R I, et al. Imaging of onset and progression of Alzheimer's disease with voxel-compression mapping of serial magnetic resonance images. Lancet 2001; 358:201-205.
86. Kaye J A, Swihart T, Howieson D, et al. Volume loss of the hippocampus and temporal lobe in the healthy elderly persons destined to develop dementia. Neurology 1997; 48:1297-304.
87. Fox N C, Warrington E K, Stevens J M, et al. Atrophy of the hippocampal formation in early familial Alzheimer's disease. A longitudinal MRI study of at-risk members of a family with an amyloid precursor protein 717Val-Glymutation. Ann NY Acad Sci 1996; 777:226-32.
88. Convit A, de Leon M J, Tarshish C, et al. Hippocampal volume losses in minimally impaired elderly. Lancet 1995; 345:266.
89. Convit A, de Leon M J, Tarshish C, et al. Specific hippocampal volume reduction in individuals at risk for Alzheimer's disease. Neurobiol Aging 1997; 18:131-8.
90. Fox N C, Warrington W K, Freeborough P A, et al. Presymptomatic hippocampal atrophy in Alzheimer's disease: a longitudinal MRI study. Brain 1996; 119:2001-2007.
91. Jack Jr C R, Petersen R C, Xu Y C, et al. Prediction of AD with MRI-based hippocampal volume in mild cognitive impairment. Neurology 1999; 52:1397-1403.
92. Du A T, Schuff N, Amend D, Laakso M P, Hsu Y Y, Jagust W J, et al. Magnetic resonance imaging of the entorhinal cortex and hippocampus in mild cognitive impairment and Alzheimer's disease. J Neurol Neurosurg Psychiatry 2001; 71:441-447.
93. Soininen H, Partanen, Pitkanen A, et al. Decreased hippocampal volume asymmetry on MRIs in nondemented elderly subjects carrying the apolipoprotein ε4 allele. Neurology 1995; 45:391-392.
94. Reiman E M, Uecker A, Caselli R J, et al. Hippocampal volumes in cognitively normal persons at genetic risk for Alzheimer's disease. Ann Neurol 1998; 44:288-291.
95. Killiany R J, Gomez-Isla T, Moss M, et al. Use of structural magnetic resonance imaging to predict who will get Alzheimer's disease. Ann Neurol 2000; 47:430-439.
96. Schott J M, Fox N C, Frost C, et al. Assessing the onset of structural change in familial Alzheimer's disease. Ann Neurol 2003; 53:181-188.
97. Scahill R I, Schott J M, Stevens J M, et al. Mapping the evolution of regional atrophy in Alzhiemer's disease: unbiased analysis of fluid-registered serial MRI. Proc Natl Acad Sci USA 2002; 99:4703-4707.
98. Chen K, Reiman E M, Alexander G E, et al. Automated method using iteractive principle component analysis for detecting brain atrophy rates from sequential MRI in persons with Alzheimer's disease, Soc Neurosci Abstr, 2001 [abstract].
99. Chen K, Reiman E M, Alexander G, et al. Whole brain atrophy rates in cognitively normal persons at genetic risk for Alzheimer's disease. Presented at the 8^{th} Internat Conf on AD and Related Dis, Stockholm, June 2002 [abstract].
100. Chen K, Reiman E M, Alexander G E, et al. Whole brain atrophy rates in cognitively normal persons at genetic risk for Alzheimer's Disease. Presented at the 8 h Internat Conf on AD and Related Dis, Stockholm, June 2002 [abstract].
101. Chen K, Reiman E M, He J, et al. Evaluation of an iterative principal component analysis for detecting whole brain volume change in small animal magnetic resonance imaging. Presented at the 8^{th} Internat Conf on AD and Related Dis, Stockholm, 2002 [abstract].
102. Hauss-Wegrzyniak B, Chen K, Galons J P, et al. Detecting an experimentally induced reduction in mouse brain volume using sequential high-resolution MRI's and the iterative PCA method. Presented at the 8^{th} Internat Conf on AD and Related Dis, Stockholm, 2002 [abstract].
103. Ashburner J, Friston K J. Voxel-based morphometry—the methods. Neuroimage 2000; 1:805-821.
104. Alexander G E, Chen K, Reiman E M, et al. Effect of apolipoprotein E on regional brain atrophy in cognitively normal ε4 homozygotes and heterozygotes using voxel-based MRI morphometry. Soc Neurosci Abstr, 2001 [abstract].
105. Alexander G E, Chen K, Reiman E M, et al. Longitudinal declines of gray matter in cognitively normal apolipoprotein E ε4 homozygotes and heterozygotes evaluated by voxel based MRI Morphometry. Presented at the 8^{th} Internat Conf on AD and Related Dis, Stockholm, 2002 [absract].
106. Alexander G E, Chen K, Reiman E M, et al. Abnormalities in gray matter density in young adults at genetic risk for late-onset Alzheimer's disease. Presented at the 8th Internat Conf on AD and Related Dis, Stockholm, June 2002 [abstract].
107. Csernansky J G, Wang L, Joshi S, et al. Early DAT is distinguished from aging by high-dimensional mapping of the hippocampus. Dementia of the Alzheimer type. Neurology 2000 Dec. 12; 55(11):1636-43.
108. Thompson P M, Mega M S, Woods R P, et al. Cortical change in Alzheimer's disease detected with a disease-specific population-based brain atlas. Cereb Cortex 2001; 11:1-16.
109. Thompson P M, Hayashi K M, de Zubicaray G, et al. Early DAT is distinguished from aging by high-dimensional mapping of the hippocampus. Dementia of the Alzheimer type. J. Neurosci. 2003 23:994-1005.
110. Temple R. A regulatory authority's opinion about surrogate endpoints. In: Nimmo W S, Tucker G T, eds. Clinical Measurement in Drug Evaluation. New York, N.Y.: John Wiley & Sons, Ltd; 1995:3-22.
111. Fleming T R, DeMets D L. Surrogate end points in clinical trials: are we being misled? Ann Intern Med 1996; 125:605-613.
112. Div Neuropharmacological Drug Products, US Food and Drug Administration. Background Document for Joint Advisory Committee Meeting of Nov. 18, 2002: Issues Related to the Role of Brain Imaging as an Outcome Measure in Phase III Trials of Putative Drugs for Alzheimer's Disease. 2002 [Memo].
113. Reiman E M, Uecker A, Gonzalez-Lima F, Minear D., Chen K, Callaway N L, Berndt, J D, Games D. Tracking Alzheimer's disease in transgenic mice using fluorodeoxyglucose autoradiography. NeuroReport 2000; 11:987-991.
114. Kuhl D E, Metter E J, Riege W H, Phelps M E. Effects of human aging on patterns of local cerebral glucose utilization determined by the 18F-fluorodeoxyglucose method. J Cereb Blood Flow Metab 1982; 2:163-71.
115. Salmon E, Sadzot B, Maquet P, Dive D, Franck G. Decrease of frontal metabolism demonstrated by positron emission tomography in a population of healthy elderly volunteers. Acta Neurol Belg 1991; 91:288-95.
116. Loessner A, Alavi A, Lewandrowski K, Mozley D, Souder E, Gur R E. Regional cerebral function determined by FDG-PET in healthy volunteers: normal patterns and changes with age. J Nucl Med 1995; 36:1141-9.
117. Coffey C E, Wilkinson W E, Parashos I A. Quantitative cerebral anatomy of the aging human brain: a cross-sectional study using magnetic resonance imaging. Neurology 1992; 42:527-36.
118. Terry R D, DeTeresa R, Hansen L A. Neocortical cell counts in normal human adult aging. Ann Neurol 1987; 21:530-9.
119. Reiman E M, Chen K, Alexander G E, Caselli R J. Positron emission tomography studies of cognitively normal persons at genetic risk for Alzheimer's disease. Presented at the IPSEN Foundation Conference on the Living Brain and Alzheimer's Disease, Paris, 2003.
120. Reiman E M, Caselli E M, Chen K, et al. Effects of age on cerebral glucose metabolism in APOE E ε4 carriers and noncarriers. Presented at the 8^{th} Internat Conf on AD and Related Dis, Stockholm, June 2002 [abstract].
121. Reiman E M, Caselli R J, Chen K, et al. Abnormalities in regional brain activity in young adults at genetic risk for late-onset Alzheimer's disease Presented at the 8^{th} Internat Conf on AD and Related Dis, Stockholm, June 2002 [abstract].
122. Games D, Adams D, Alessandrini R, et al. Alzheimer-type neuropathology in transgenic mice overexpressing V717F β-amyloid precursor protein. Nature 1995; 373:523-527.
123. Hsiao K, Chapman P, Nilsen S, et al. Correlative memory deficits, AP elevation, and amyloid plaques in transgenic mice. Science 1996; 274:99-102.
124. Holcomb L, Gordon M N, McGowan E, et al. Accelerated Alzheimer-type phenotype in transgenic mice carrying both mutant amyloid precursor protein and presenilin 1 transgenes. Nature Med 1998; 4:97-100.
125. Terry R D, Masliah E, Salmon D P, et al. Physical basis of cognitive alterations in Alzheimer's disease: synapse loss is the major correlate of cognitive impairment. Ann Neurol 1991; 30:572-580.
126. Bierer L M, Haroutunian V, Gabriel S, et al. Neocortical neurofibrillary tangles correlate with dementia severity in Alzheimer's disease. Arch. Neurol. 1995; 52:81-88.
127. Morris J C, Olichney J M, Thal L J, et al. Cerebral amyloid deposition and diffuse plaques in “normal” aging: Evidence for presymptomatic and very mild Alzheimer's disease. Neurology 1996; 46:707-719.
128. Gonzalez-Lima F, Berndt J D, Valla J, Games D, Reiman E M. Reduced corpus callosum, fornix and hippocampus in PDAPP transgenic mouse model of Alzheimer's disease. NeuroReport 2001; 12:2375-2379.
129. Valla J, Chen K, Berndt J D, et al. Effects of image resolution on autoradiographic measurements of posterior cingulate activity in PDAPP mice: Implications for functional brain imaging studies in transgenic mouse models of Alzheimer's disease. NeuroImage 2002; 16:1-6.
130. Valla J, Lewandowski L, Duff K, Reiman E M. No evidence of significant white matter disruption in the TG2576 mouse model of Alzheimer's disease: implications for in vivo microimaging. Presented at the 8^{th} Internat Conf on AD and Related Dis, Stockholm, June 2002 [abstract].
131. Valla J, Berndt J D, Gonzalez-Lima F. Energy hypometabolism in posterior cingulate cortex of Alzheimer's patients: superficial laminar cytochrome oxidase associated with disease duration. J. Neurosci. 2001; 21:4923-30.

1. In a method using one or more measurements taken in real persons at two or more different times each of which is found in the absence of treatment to be associated with statistically significant (i) rates of change in AD patients, or (ii) greater rates of change in MCI patients who subsequently show further cognitive decline than in MCI patients who do not, or (iii) greater rates of change in persons thought to be at higher AD risk that are cognitively normal or not disabled by AD than persons thought to be at lower AD risk that are cognitively normal or not disabled by AD, the method comprising:
for the real persons who have an AD risk factor but do not have clinically significant cognitive impairment, characterizing the rate of change in each said measurement over a time period during or following the real persons' treatment with a putative AD prevention therapy;
for hypothetical persons who are similar to the real persons in their risk for AD, age, and absence of clinically significant cognitive impairment but who are not treated with the putative AD prevention therapy, characterizing the rate of change in the same measurement over a like time interval; and
suggesting the efficacy of the putative AD prevention therapy by a finding of a statistically smaller rate of change in each said measurement over the like time interval for the real persons treated with the putative AD prevention therapy than in the hypothetical persons that are not treated with the putative AD prevention therapy.

2. The method as defined in claim 1, wherein each said measurement is selected from the group consisting of a brain imaging measurement, an electrophysiological measurement, a biochemical measurement, a molecular measurement, a transcriptomic measurement, a proteomic measurement, a cognitive measurement, a behavior measurement, and a combination of the foregoing.

3. The method as defined in claim 1, wherein:
one said measurement is the cerebral metabolic rate for glucose (CMRgl) in brain regions found to have a greater rate of CMRgl decline in cognitively normal persons at higher risk for AD than in those with a lower risk;
CMRgl is measured using fluorodeoxyglucose (FDG) positron emission tomography (PET); and
the real and hypothetical persons each have at least one copy of the APOE ε4 allele.

4. The method as defined in claim 1, wherein:
each said measurement can be used to measure the rate of change in brain tissue volume or the rate of change in cerebrospinal fluid volume so as to provide information about the rate of brain atrophy;
the brain tissue volume or the cerebrospinal fluid volume is measured using magnetic resonance imaging (MRI); and
the real and hypothetical persons each have at least one copy of the APOE ε4 allele.

5. The method as defined in claim 1, wherein each said measurement is suggested to provide an indirect assessment of AD pathology.

6. The method as defined in claim 5, where the AD pathology is selected from the group consisting of the loss of intact neurons or synapses, the formation of amyliod plaques, the formation of neurofibrillary tangles, and a combination of the foregoing.

7. The method as defined in claim 1, wherein each said measurement is selected from the group consisting of a concentration of amyloid proteins, a concentration of amyloid oligimers, a concentration of amyloid plaques, a concentration of tau, a concentration of phosphorylated tau proteins, a concentration of tangles, a concentration of F2-isoprostanes, a concentration of lipid peroxidation, a concentration of inflammatory, activated microglial, a molecular immune change, and a molecular change associated with the progression of AD.

8. The method as defined in claim 1, wherein each said measurement is selected from the group consisting of a reflection of the activity or integrity of brain cells, and a reflection of the activity or integrity of white matter tracks, and a combination of the foregoing.

9. The method as defined in claim 1, wherein each said measurement is selected from the group consisting of a neurotransmitter characteristic, a neuroreceptor characteristic, a neurochemical characteristic, a molecular characteristic, a physiological characteristic, and a combination of the foregoing.

10. The method as defined in claim 1, wherein each said measurement made by a technique selected from the group consisting of a brain imaging technique, a biological assay, and combination of the foregoing.

11. The method as defined in claim 10, wherein the biological assay is performed using a sample selected from the group consisting of a body fluid, cerebrospinal fluid, blood, saliva, urine, a body tissue.

12. The method as defined in claim 10, wherein the brain imaging technique is selected from the group consisting of:
different PET and single photon emission tomography radiotracer methods;
structural, functional, perfusion-weighted, or diffusion-weighted MRI;
x-ray computed tomography;
magnetic resonance spectroscopy measurements of N-acetyl aspartic acid, myoinositol, and other chemical compounds;
electroencephalography, quantitative electroencephalography, event-related potentials, and other electrophysiological procedures;
magnetoencephalography; and
a combination of the foregoing.

13. The method as defined in claim 1, wherein the AD risk factor is selected from the group consisting of a genetic risk factor, a non-genetic risk factor, and a combination of the foregoing.

14. The method as defined in claim 1, wherein the genetic risk factor is selected from the group consisting of the presence of 1 or 2 copies of the APOE ε4 allele, the presence of other confirmed susceptibility genes, the presence of a presenilin 1 mutation, presenilin 2 mutation, amyloid precursor protein mutation, or other mutations or gene shown to cause AD, an aggregate genetic risk score that is based upon a person's number of susceptibility genes and their individual contribution to an AD risk, a family history of AD, and a combination of the foregoing.

15. The method as defined in claim 1, wherein the non-genetic risk factor is selected from the group consisting of:
head trauma associated with loss of consciousness;
a higher than normal cholesterol level;
a higher than normal homocysteine level;
a brain imaging measurement thought to be associated with a higher than normal risk of subsequent cognitive decline, MCI, or AD;
being at least 60 years of age;
a biological marker associated with a higher that normal risk of subsequent cognitive decline, MCI, or AD;
a cognitive measurement thought to be associated with a higher than normal risk of subsequent cognitive decline, MCI, or AD;
a behavioral measurement thought to be associated with a higher than normal risk of subsequent cognitive decline, MCI, or AD; and
a combination of the foregoing.

16. The method as defined in claim 1, wherein the validity of each said measurement as a “therapeutic surrogate” is further supported to suggest the efficacy of the putative AD prevention therapy by a statistically significant relationship between rates of change in each said measurement over the like time interval and subsequent clinical decline in patients with AD or MCI or in cognitively normal or non-disabled persons at AD risk.

17. The method as defined in claim 1, wherein the validity of each said measurement as a “therapeutic surrogate” is further supported to suggest the efficacy of the putative AD prevention therapy by a statistically significant showing of how the ability of the putative AD prevention therapy to slow the rate of change in each said measurement over the like time interval is associated with slower rates of subsequent clinical decline in patients with AD or MCI or cognitively normal or non-disabled persons at AD risk.

18. The method as defined in claim 1, wherein the putative AD prevention therapy is selected from the group consisting of a pharmacological prescription, an over-the-counter medication, an immunization therapy, a biological therapeutic, a dietary supplement, a dietary change, a physical exercise, a mental exercise, a lifestyle change intended to promote healthy living, decrease the risk of cognitive decline, MCI, AD, or cardiovascular disease, and a combination of the foregoing.

19. Treating a patient with an AD prevention therapy the efficacy of which is suggested by the method of claim 1.

20. The treatment as defined in claim 19, wherein the patient has AD, MCI, or is a cognitively normal or non-disabled person who has an AD risk factor.

21. In a method using one or more measurements taken in real persons at two or more different times, each of which is found in the absence of treatment to be associated with statistically significant (i) rates of change in patients having a neurodegenerative disease or (ii) greater rates of change in persons at higher risk for the neurodegenerative disease but not disabled by the neurodegenerative disease than those in persons at lower risk for the neurodegenerative disease, the method comprising:
for the real persons who have a neurodegenerative disease risk factor but do not have clinically significant cognitive impairment, characterizing the rate of change in each said measurement over a time period during or following the real persons' treatment with a putative neurodegenerative disease prevention therapy;
for hypothetical persons who are similar to the real persons in their risk for the neurodegenerative disease, age, and absence of clinically significant cognitive impairment but who are not treated with the putative neurodegenerative disease prevention therapy, characterizing the rate of change in the same measurement over a like time interval;
suggesting the efficacy of the putative neurodegenerative disease prevention therapy by a finding of a statistically smaller rate of change in each said measurement over the like time interval for the real persons treated with the putative neurodegenerative disease prevention therapy than in the hypothetical persons that are not treated with the putative neurodegenerative disease prevention therapy.

22. The method as defined in claim 21, wherein the neurodegenerative disease is selected from the group consisting of Alzheimer's disease, Dementia with Lewy Bodies, Parkinson's disease, Parkinson's dementia, a frontotemporal dementia, a tauopathy, other progressive dementias, amyotropic lateral sclerosis, other progressive neuromuscular disorders, multiple sclerosis, other progressive neuroimmunological disorders, Huntington's disease, a focal or generalized brain disorder which involves a progressive loss of brain function over time, and a combination of the foregoing.

23. The method as defined in claim 21, wherein:
one said measurement is the cerebral metabolic rate for glucose (CMRgl) in brain regions found to have a greater rate of CMRgl decline in patients with Parkinson's disease patients who subsequently development Parkinson's dementia than in Parkinson's patients who do not subsequently develop Parkinson's dementia;
CMRgl is measured using fluorodeoxyglucose (FDG) positron emission tomography (PET); and
the real and hypothetical persons each have Parkinson's disease but do not have dementia at the beginning of the like time interval.

24. The method as defined in claim 21, wherein each said measurement is selected from the group consisting of a brain imaging measurement, an electrophysiological measurement, and a combination of the foregoing.

25. The method as defined in claim 21, wherein each said measurement is selected from the group consisting of a biochemical assay, a molecular assay, and a combination of the foregoing.

26. The method as defined in claim 21, wherein at least one of said measurements has a greater rate of change in persons at a higher risk for the neurodegeneragive disease that in persons at a lower risk for the neurodegeneragive disease in the absence of disabling symptoms of the neurodegeneragive disease.

27. The method as defined in claim 21, wherein the validity of each said measurement as a “therapeutic surrogate” is further supported to suggest the efficacy of the putative neurodegenerative disease prevention therapy by a statistically significant relationship between rates of change in each said measurement over the like time interval and subsequent clinical decline in patients affected by or at risk for the neurodegenerative disease.

28. The method as defined in claim 21, wherein the validity of each said measurement as a “therapeutic surrogate” is further supported to suggest the efficacy of the putative neurodegenerative disease prevention therapy by a statistically significant showing of how the ability of the putative neurodegenerative disease prevention therapy to slow the rate of change in each said measurement over the like time interval is associated with slower rates of subsequent clinical decline in patients affected by or at risk for the neurodegenerative disease.

29. The method as defined in claim 21, wherein the putative neurodegenerative disease prevention therapy is selected from the group consisting of a pharmacological prescription, an over-the-counter medication, an immunization therapy, a biological therapeutic, a dietary supplement, a dietary change, a physical exercise, a mental exercise, a lifestyle change intended to promote healthy living, reduced the risk of the neurodegenerative disorder or its symptoms, or reduce the risk of cardiovasculare disease, and a combination of the foregoing.

30. Treating a patient with a neurodegenerative disease prevention therapy the efficacy of which is suggested by the method of claim 21.

31. The treatment as defined in claim 30, wherein the patient has a neurodegenerative disease or has a neurodegenerative disease risk factor.

32. In a method using one or more measurements taken in real persons at two or more different times, each of which is found in the absence of treatment to be associated with statistically significant rates of change associated with aging in patients who do not have clinical signs or symptoms of a progressive brain disorder, the method comprising:
for the real persons who do not have clinical signs or symptoms of a progressive brain disorder, characterizing the rate of change in each said measurement over a time period during or following the real persons' treatment with a putative therapy to slow an aspect of brain aging;
for hypothetical persons who are similar to the real persons their age and absence of clinically significant signs of symptoms of a brain disorder but who are not treated with the putative therapy to slow an aspect of brain aging, characterizing the rate of change in the same measurement over a like time interval;
suggesting the efficacy of the putative therapy to slow an aspect of brain aging, thereby delaying the onset of disorders that are caused in part by those aging changes by a finding of a statically smaller rate of change in each said measurement over the like time interval for the real persons treated with the putative therapy to slow an aspect of brain aging than in the hypothetical persons that are not treated with the putative therapy to slow an aspect of brain aging.

33. The method as defined in the claim 32, wherein one said measurement is the cerebral metabolic rate for glucose (CMRgl) in brain regions found to be affected by normal aging, healthy aging, or very health aging.

34. The method as defined in the claim 33, wherein CMRgl is measured using fluorodeoxyglucose (FDG) positron emission tomography (PET).

35. The method as defined in the claim 33, wherein:
normal aging is characterized by the absence of a brain disorder of the absence of a medical problem that could affect the brain;
healthy aging is further characterized by the absence of any signs or symptoms of an age-related brain disorder; and
very health aging is further characterized by the absence of one or more known risk factors for an age-related disorder.

36. The method as defined in the claim 35, wherein the risk factor is having a copy of the APOE ε4 allele.

37. The method as defined in the claim 32, wherein each said measurement is selected from the group consisting of a brain imaging measurement, an electrophysiological measurement, and a combination of the foregoing.

38. The method as defined in claim 32, wherein each said measurement is selected from the group consisting of a biochemical assay, a molecular assay, a measurement of oxidative stress, and a combination of the foregoing.

39. The method as defined in claim 32, wherein the validity of each said measurement as a “therapeutic surrogate” is further supported to suggest the efficacy of the putative therapy to slow an aspect of brain aging by a statistically significant showing that the rate of change in each said measurement over the like time interval is predictive of an age-related cognitive decline or a behavioral decline.

40. The method as defined in claim 32, wherein the validity of each said measurement as a “therapeutic surrogate” is further supported to suggest the efficacy of the putative therapy to slow an aspect of brain aging by a statistically significant showing that the rate of change in each said measurement over the like time interval is predictive of and subsequent age-related decline in cognitive, behavioral, or other neurological abilities.

41. The method as defined in claim 32, wherein the validity of each said measurement as a “therapeutic surrogate” is further supported to suggest the efficacy of the putative therapy to slow an aspect of brain aging by a statistically significant showing that the rate of change in each said measurement over the like time interval is predictive of one or more age-related disorders that are more likely to be found in aged individuals.

42. The method as defined in claim 32, wherein the validity of each said measurement as a “therapeutic surrogate” is further supported to suggest the efficacy of the putative therapy to slow an aspect of brain aging by a statistically significant showing that the rate of change in each said measurement over the like time interval is associated with slower rates of:
age-related cognitive decline;
age-related behavioral decline;
other age-related neurological, neuropsychological, or psychiatric declines; or
the onset of an age-related disorder.

43. The method as defined in claim 32, wherein the putative therapy to slow an aspect of brain aging is selected from the group consisting of a pharmacological prescription, an over-the-counter medication, an immunization therapy, a biological therapeutic, a dietary supplement, a dietary change, a physical exercise, a mental exercise, a lifestyle change intended to promote healthy living, a lifestyle change intended to promote healthy mental function, a lifestyle change intended to decrease a risk of cardiovascular disease, and a combination of the foregoing.

44. Treating a patient with a therapy to slow an aspect of brain aging the efficacy of which is suggested by the method of claim 32.

45. The treatment as defined in claim 44, wherein the patient may or may not have an age-related disorder and may or may not have a risk factor for an age-related disorder.
